(19) United States
(12) Patent Application Publication
(10) Pub. No.: US 2019/0315988 A1
(43) Pub. Date: Oct. 17, 2019

(54) CO-POLYMERS

(71) Applicant: UNIVERSITY COLLEGE CARDIFF CONSULTANTS LTD, Cardiff, South Wales (GB)

(72) Inventors: Davide Bonifazi, Cardiff (GB); Dario Mosca, Gembloux (BE); César Laia, Lisboa (PT); Jorge Parola, Lisboa (PT); Fernando Pina, Almada (PT); Carlos Pinherio, Freiburg im Breisgau (DE)

(21) Appl. No.: 16/343,133

(22) PCT Filed: Oct. 20, 2017
(86) PCT No.: PCT/GB2017/053171

§ 371 Date: Apr. 18, 2019

(30) Foreign Application Priority Data
Oct. 20, 2016 (GB) 1617742.0

(51) Int. Cl. C09D 11/52; C08G 61/12; C08K 3/04; C08K 9/02; C09D 11/50; C09D 11/033; C09D 11/037; C09D 11/102; G02F 1/155

(52) U.S. Cl. CPC C09D 11/52; C08K 2201/011; C08K 3/041; C08K 9/02; C09D 11/50; C09D 11/033; C09D 11/037; C09D 11/102; G02F 1/155; C08G 2261/12; C08G 2261/1424; C08G 2261/148; C08G 2261/3223; C08G 2261/3247; C08G 2261/43; C08G 2261/54; C08G 61/126

(57) ABSTRACT

Co-polymers formed from at least one monomer of formula (A) and at least one monomer of formula (B): (A) (B) wherein R¹, R², R³ and L are as defined herein; may be dispersed or dissolved in an organic solvent which optionally contains carbon nanostructures. A substrate coated or printed with the dispersion or solution may be used in an electrochromic device.

The present application relates to a polymer and a dispersion comprising said polymer and carbon nanotubes suitable for coating and printing substrates and use in electrochromic devices. Also disclosed are methods for making said dispersion and electrochromic devices comprising the polymer or dispersion.

### BACKGROUND

Electrochromic devices (ECDs) are materials that are able to change their colour through redox reactions triggered by voltage changes upon the application of an external electric field and have attracted a lot of consideration due to their potential applications, such as smart windows, mirrors and displays. The advantage of ECDs over liquid crystal display technology include reduced material costs and compatibility with flexible surfaces.

A typical electrochromic device comprises five superimposed layers on a transparent substrate whereby two electrodes sandwich an outer electroactive layer which is joined through an ion conductor layer to the electrochromic layer. A voltage applied between the transparent electrodes leads to charge being transported between the EC and electroactive layer altering the transparency.

In order to obtain efficient ECDs, the electroactive layer must be transparent and must have a good fatigue resistance upon the application of different voltages. Historically indium doped Tin oxide (ITO) was found to be a suitable material and electrochromic devices comprising ITO are disclosed in application No JPH03158831 or U.S. Pat. No. 4,775,227; however due to its prohibitively high cost, ITO-free materials or materials which improve the function of ITO thus providing significant cost savings are sought after. Prussian Blue (PB), viologens and organic polymers such as π-conjugated organic polymers and specifically poly-thiophenes (PT), for example poly 3,4-alkyldioxythiophene (PEDOT) are compounds suitable to support the function of the ITO. Electrochromic films employing PEDOT are disclosed in application CN105001436 or U.S. Pat. No. 7,158,277. The PT polymers are particularly useful because of their electrochemical stability and conductivity, also having a low oxidation potential thus preventing the deterioration of the ITO and increasing the number of charging and discharging cycles. Doping of poly(3-methyl-2-{[3-(4-vinyl-benzyl)-3H-benzothiazol-2-ylidene]-hydrazono}-2,3-dihydro-benzothiazole-6-sulfonic) acid (polyABTS) on PEDOT was also found to decrease switching times and prevent deterioration.

EC films are produced by direct electropolymerization of surfaces such as glass or a polymeric substrate such as polyethylene terephthalate (PET). However, electropolymerization is often associated with defects in the EC film, such as the formation of aggregates or dimers or non-electrochemical oxidation of the electrochromic compounds which compromises the performance of the electrochromic layer. Moreover, deposition of the transparent conductors such as ITO on flexible substrates such as PET reduces the conductivity significantly when compared to the conductivity obtained when deposited on glass.

To improve the characteristics of the ECDs, the polymeric layer has been doped with semiconducting materials such as graphene or carbon nanotubes (CNTs), which may be Multi Wall (MWCNTs) or Single Wall (SWCNTs) carbon nanotubes. An electrochromic device with a transparent graphene/ferroelectric electrode is disclosed in US2016/0259224. Films made of randomly distributed SWCNTs were shown to exhibit high optical transparency, robust mechanical flexibility and thermal stability. Similarly, electrochromic compositions comprising a dispersion of EDOT and multiwall carbon nanotubes (MWCNTs) provided electrochromic materials with better endurance and performance having increased number of switching cycles and shorter bleaching and switching times (S. Bhandari, M. Deepa, A. K. Srivastava, A. G. Joshi, R. Kant, J. Phys. Chem. B 2009, 113, 9416-9428).

The applicants of the present disclosure have developed a novel polymer which can be doped with CNT, for example MWCNT and particularly pristine MWCNT (p-MWCNT) and can be homogenously dispersed and deposited on a flexible substrate. The coated or printed substrate can be used in the manufacture of an electrochromic device that has improved switching cycles, switching and bleaching times and maintains good light transmittance.

### STATEMENT OF THE INVENTION

According to an aspect of the invention there is provided a copolymer formed from at least one monomer of formula (A) and at least one monomer of formula (B)

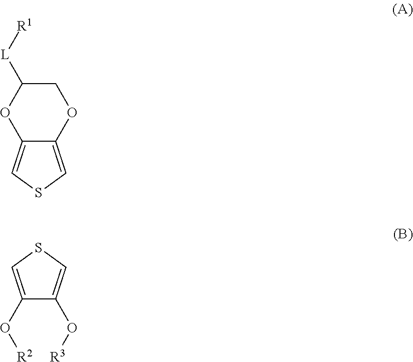

where R¹ is a polyaromatic or polyheteroaromatic ring or molecular graphenes of less than 22.000 g/mol;
L is a C₁₋₆ alkylene, C₂-5 alkenylene or C₂₋₆ alkynylene linker wherein one or two carbon atoms are optionally replaced with O, S or NH;
each of R² to R³ are independently selected from the group consisting of:
C₆₋₁₄ alkyl, which may optionally comprise a C₃₋₇ cycloalkyl, C₆₋₁₀ aryl or C₅₋₁₀ heteroaryl group and wherein a carbon atom of the alkyl chain is optionally replaced with O, S or NH;
C₃₋₇ cycloalkyl, C₆₋₁₀ aryl or C₅₋₁₀ heteroaryl;
a polyalkylene glycol radical;
or R² and R³ together with the atoms to which they are attached may form a 5-10 membered heterocyclic ring, optionally containing a further heteroatom selected from O, S or NH; and the molar ratio of the monomer of formula (B) to the monomer of formula (A) is from 3:1 to 15:1.

In the context of the present specification, the term “C₆₋₁₄ alkyl” refers to a fully saturated hydrocarbon chain which may be straight or branched and which contains from 6 to 14 carbon atoms. Examples include n-hexyl, n-heptyl, n-nonyl, n-decyl, 2-ethylbutyl, 2-ethylpentyl, 2-ethylhexyl, 2-ethylheptyl, 4-propylheptyl and 4-butyloctyl.

Where the alkyl group comprises a C₃₋₇ cycloalkyl, C₆₋₁₀ aryl or C₅₋₁₀ heteroaryl group, the 6 to 14 carbon atoms include the ring atoms of the cycloalkyl, aryl or heteroaryl group and the ring may be a substituent or may be comprised within the carbon chain. Examples include 4-cyclohexylbutyl, 2-cyclohexylpentyl, 2-cyclohexylheptyl and 3-propylcyclohexylmethyl.

Other alkyl groups, for example C₁₋₆ alkyl or C₈₋₁₀ alkyl are as defined above for C₆₋₁₄ alkyl except that the number of carbons is different.

The term “C₃₋₇ cycloalkyl” refers to a fully saturated carbocyclic ring having from 3 to 7 carbon atoms. Examples include cyclopropyl, cyclobutyl, cyclopentyl, cyclohexyl and cycloheptyl.

In the context of the present specification “C₁₋₆ alkylene” is a straight or branched fully saturated hydrocarbon linker having from 1 to 6 carbon atoms. Examples include methylene, ethylene (—CH₂CH₂—), propylene, 1-methylethylene, 2-methylethylene and 2-methylpropylene.

In the context of the present specification “C₂₋₆ alkenyl” is a straight or branched hydrocarbon chain having at least one carbon-carbon double bond and from 2 to 6 carbon atoms. An alkenyl group may contain more than one carbon-carbon double bond, for example two, three, four or five carbon-carbon double bonds. Examples include ethenyl, propen1-yl, n-hexen-2-yl and 2,4-hexadienyl.

In the context of the present specification “C₂₋₆ alkynyl” a straight or branched hydrocarbon chain having from two to 6 carbon atoms and at least one carbon-carbon triple bond. An alkynyl group may contain more than one carbon-carbon triple bond, for example two, three four or five carbon-carbon triple bonds. In some cases, the alkynylene group may contain one or more carbon-carbon double bond in addition to the one or more carbon-carbon triple bonds. Examples include ethynyl, propyn-1-yl and n-hexyn-2-yl.

In the context of the present specification “C₂₋₆ alkenylene” is a straight or branched hydrocarbon linker having at least one carbon-carbon double bond and from 2 to 6 carbon atoms. An alkenylene linker may contain more than one carbon-carbon double bond, for example two, three, four or five carbon-carbon double bonds Examples include ethenylene (i.e. —CH═CH—), propen1-ylene, n-hexen-2-ylene, 2,4-hexadienylene,

In the context of the present specification “C₂₋₆ alkynylene” is a straight or branched hydrocarbon linker having from two to 6 carbon atoms and at least one carbon-carbon triple bond. An alkynylene linker may contain more than one carbon-carbon triple bond, for example two, three four or five carbon-carbon triple bonds. In some cases, the alkynylene linker may contain one or more carbon-carbon double bond in addition to the one or more carbon-carbon triple bonds. Examples include ethynylene (—C≡C—), propyn-1-ylene and n-hexyn-2-ylene.

In the context of the present specification “polyalkylene glycol radical” is a radical derived from a polyalkylene glycol by removal of a hydrogen atom. Preferred polyalkylene glycols are selected from polyethylene oxides, polypropylene oxides and polyethylene oxide/polypropylene oxide copolymers. More preferably, the polyalkylene glycol is a polyethylene oxide. As used herein, the term “polyethylene oxide” refers to a (co)polymer comprising —[OCH₂—CH₂]— repeating groups. Similarly, the term “polypropylene oxide” refers to a (co)polymer comprising —[OCH₂CH₂CH₂]— and/or —[OCH(CH₃)CH₂]— repeating groups.

The polyalkylene glycols comprise at least 2 alkylene oxide repeating groups. Preferably, the polyalkylene glycols comprise no more than 20, more preferably no more than 10, still more preferably no more than 5, and most preferably no more than 4 alkylene oxide repeating groups.

The term “polyaromatic” refers to a carbocyclic ring system having 9 to 100 ring atoms and at least two rings, wherein at least one ring is aromatic in character.

The term “polyheteroaromatic” refers to a ring system having 9 to 100 ring atoms, at least one of which is N, O or S, and having at least two rings, at least one of which is aromatic in character.

Suitably, in the polymers of the invention the ratio of monomer (B) to monomer (A) is from 8:1 to 12:1 and typically 10:1.

The polymers typically have an average molecular weight of 2000 to 100000 Da. More usually, the average molecular weight is 2000 to 50000 Da, more suitably 2000 to 20000, for example about 2000 to 10000, or about 3000 to 5000 Da.

Suitably, the copolymer formed from the monomer of formula (A) and the monomer of formula (B) is a polymer of general formula (I)

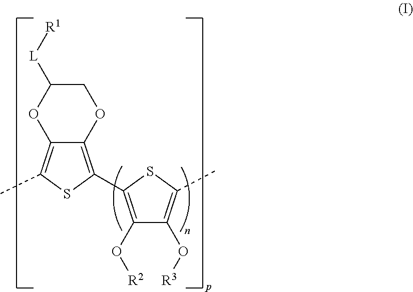

wherein L, R¹, R² and R³ are defined as above and wherein, within the polymer R¹ groups may have differing values, R² groups may have differing values and R³ groups may have differing values;
n is 3-15; and
p is 3 to 140

Suitably, p is from 3 to 100, more suitably 3 to 80, still more suitably from 3 to 50 or 3 to 30, for example from 3-28. The role of the R¹ moiety in the polymers of the present invention is to form an interaction with a carbon nanotube. Thus, the R¹ moiety is aromatic in character such that it is able to form a strong π-π interaction with carbon nanostructures. For this reason, the R¹ moiety is not generally substituted since this would affect the π bonding interaction.

In some suitable polymers of the invention R¹ groups have at least 3 rings, at least 2 of which are aromatic in character.

In other suitable compounds of the invention R¹ is a polyaromatic ring system selected from the group consisting of benzo[a]pyrene, anthracene, chrysene, pyrene, phenanthracene, naphthalene and tetracene or a polyheteroaromatic group selected from indole, quinoline, isoquinoline and polypyrroles,

In some particularly suitable polymers of the invention R¹ is pyrene.

Alternatively, R¹ may be molecular graphenes as defined above. The role of the L linker is to link the group R¹, to which carbon nanostructures are attached, to the PEDOT moiety of the polymer. L is therefore suitably a short linker group as this ensures that any carbon nanostructures will be as close as possible to the PEDOT moiety.

In preferred polymers therefore, L is a C₁₋₄ alkylene linker, wherein one carbon atom is optionally replaced with O, S or NH.

Specific examples of L linkers include the following:

—CH₂—, —CH₂CH₂—, —CH₂O—, —OCH₂—, —CH₂CH₂CH₂—, —CH₂OCH₂—, —CH₂NHCH₂—

Suitably, each of R² and R³ is independently C₈₋₁₂ alkyl and optionally comprises a C₃₋₇ cycloalkyl ring.

In some cases R² and R³ are the same.

Examples of R² and R³ groups include 2-ethylheptyl and 2-ethylhexyl.

In particularly suitable polymers of the invention, the monomer of formula (A) is 2-((pyren-1-ylmethoxy)methyl)-2,3-dihydrothieno[3,4-b][1,4]dioxine; and/or the monomer of formula (B) is 3,4-bis((2-ethylhexyl)oxy)thiophene.

As mentioned above, in the polymers of the invention, the molar ratio of the monomer of formula (B) to the monomer of formula (A) is from 8:1 to 12:1 and typically 10:1. Thus, when the polymer is a polymer of general formula (I), n is 8-12, for example 10.

According to a further aspect of the invention, there is provided a process for the preparation of a polymer as defined above, the process comprising reacting a monomer of formula (A) as defined above with a monomer of formula (B) as defined above in the presence of an oxidising agent, wherein the molar ratio of the monomer of formula (B) to the monomer of formula (A) is from 3:1 to 15:1, suitably from 8:1 to 12:1, for example 10:1.

Suitably, the oxidising agent comprises iron (III) chloride, which is present in excess such that, for example the molar ratio of iron (III) chloride to the monomer of formula (B) is at least 3:1, more usually at least 5:1. For example the molar ratio of iron (III) chloride to the monomer of formula (B) is typically from 3:1 to 7:1, for example about 4:1 to 6:1.

The polymerisation reaction suitably takes place in an organic solvent such as ethyl acetate at a temperature of from about 10 to 30° C., more usually 15 to 25° C. and typically at room temperature.

The polymerisation process is described in detail in the examples below.

Suitable features of the monomers of formulae (A) and (B) and of the molar ratio are as described above for the first aspect of the invention.

A monomer of formula (A) in which the linker L comprises a heteroatom O, S or NH may be prepared from a compound of formula (IIA):

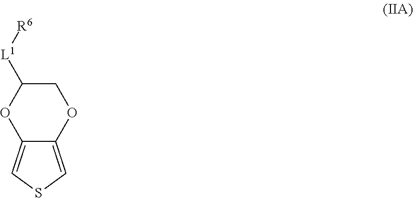

wherein L¹ is C₁₋₅ alkylene and R⁶ is OH, SH, NH₂;
by reaction with a compound of formula (IIIA):

R¹—X (IIIA)

where R¹ is as defined above for the monomer of formula (A) and X is a leaving group such as halo, toluene sulfonyl or methane sulfonyl.

Compounds of formulae (IIA) and (IIIA) are known and are either readily available or may be synthesised by known methods.

A monomer of formula (A) in which the linker L does not comprise a heteroatom may be prepared by known methods, for example a compound of general formula (IIA) above, in which R⁶ is OH may be reduced using any suitable reducing agent to convert CH₂OH to an aldehyde.

This may then be reacted with a compound of general formula (IIIA) according to any known method, for example under Wittig conditions (i.e. in the presence of triphenyl phosphine), to give a monomer of formula (A) in which the linker L is an alkenylene linker. If required, this can be reduced, for example by catalytic hydrogenation to give a monomer of formula (A) in which the linker L is an alkylene group.

Monomers of formula (B) may be prepared from compounds of formula (IIB):

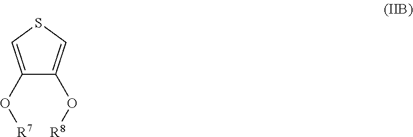

wherein each of R⁷ and R⁸ is independently C₁₋₆ alkyl or benzyl;
by reaction with a compound of general formula (IIIB):

R²—OH (IIIB)

wherein R² is as defined above for monomer B;
in the presence of an acid.

Suitably, the acid is the conjugate acid of a leaving group, for example toluene sulfonic acid or methane sulfonic acid. Concentrated hydrochloric acid may also be used.

The reaction suitably takes place under an inert atmosphere such as argon. The reaction typically takes place in a high boiling organic solvent such as toluene and at the reflux temperature of the solvent.

Alternatively, monomers of formula (B) in which R₂ and R₃ are both radicals of the same polyalkylene glycol (e.g. triethylene glycol monomethyl ether) may be prepared by reacting compounds of formula (IIB) with said polyalkylene glycol (e.g. triethylene glycol monomethyl ether), wherein said polyalkylene glycol is provided in excess and also serves as a solvent.

Monomers of formula (B) in which R² and R³ are not the same may be prepared by successively reacting stoichiometric amounts of different compounds of (IIIB) with the compound of formula (IIB)

Compounds of formulae (IIB) and (IIIB) are known and are either readily available or may be synthesised by known methods.

The polymers of the invention are intended to be used in forming an electrochromic layer and in order to do this, they must be capable of being dispersed in a suitable solvent.

According to an aspect of the invention there is provided a dispersion or a solution comprising a copolymer according to the invention and an organic solvent.

Suitably, the organic solvent is selected from the group consisting of toluene, N,N-dimethylformamide (DMF), acetonitrile, tetrahydrofuran (THF), ethyl acetate, chloroform, a polyalkylene glycol and mixtures thereof.

More suitably, the organic solvent is selected from the group of chloroform, toluene and especially mixtures of toluene and chloroform.

Still more suitably, the organic solvent is a mixture of chloroform and toluene, preferably a mixture of toluene:chloroform in a volume ratio of 1:1 to 1:10, particularly 1:5 v/v.

In suitable dispersions of the invention, the copolymer is present at a concentration between 0.5 to 1.5 g/l, more suitably between 0.8 and 1 g/l, and preferably at 0.8 or 1 g/l.

More suitably, said dispersion further comprises carbon nanostructures, for example nanostructures selected from the group consisting of carbon-based nanotubes, sheets, nanocones, nanohorns, nanoribbons, nanoplatelets, nanofibers, graphene, crystalline nanoparticles, nanodots, graphene quantum dots and amorphous nanoparticles. Said carbon nanostructures are optionally metal-containing carbon nanostructures. Preferably such metal-containing carbon nanostructures contain a metal selected from the group consisting of iron, cobalt, nickel, copper, gold, silver, tin, palladium and platinum.

Still more suitably, the carbon nanostructures are nanotubes, wherein said nanotubes are selected from single wall carbon nanotubes (SWCNTs) and multi wall carbon nanotubes (MWCNTs).

More suitably, the carbon nanotubes are MWCNTs, especially pristine MWCNTs.

Suitably, said dispersion contains 2-15 wt % carbon nanostructures, more suitably 2.5-12.5, usually 7.5 wt % wherein weight percentages are given with respect to the polymer.

The presence of the carbon nanostructures increases the dispersibility of the polymer in the solvent.

In a preferred embodiment of the invention said composition has a resistivity when coated or printed on PET of between 50-130, 10-50, 8-20, 1.4-1.5, 0.11-1.1 or 0.07-0.12 MD.

According to an aspect of the invention there is provided a substrate coated or printed with a composition comprising the copolymer of the invention. Preferably, the substrate is coated with a composition comprising the copolymer of the invention.

Suitably, the composition is obtained by removing the solvent from a dispersion as described above and therefore suitably the composition further comprises carbon nanostructures, particularly carbon nanotubes, for example MWCNTs and especially pristine MWCNTs.

Suitably said substrate is in form of a film or panel Suitably, said substrate is optically transparent.

Said substrate may be formed from a fibrous material.

Alternatively, said substrate may be glass or a polymer such as for example acrylic, polystyrene, polycarbonate, allyl diglycol, styrene acrylonitrile copolymer, poly(4-methyl 1-pentene), polyester, polyamide or polyethylene terephthalate (PET).

Substrates may be flexible and may be formed from a polymer such as those mentioned above, with PET being a particularly suitable substrate.

Suitably, the substrate further comprises an electrically conductive material.

In this case, the electrically conductive material may be a transparent conductive oxide, such as indium doped tin oxide, carbon nanotubes, graphene, nanowire meshes or ultrathin metal.

Alternatively, the electrically conductive material may be an organic semi-conductive material, such as a π-conjugated organic conductive polymer. Such π-conjugated organic conductive polymers may be selected from the group consisting of poly-thiophenes such as PEDOT, polyaniline, polyacetylene, polypyrrole, polyphenylene sulphide and polyphenylene vinylene.

Preferably, the electrically conductive material is a transparent conductive oxide.

A particularly suitable substrate for use in the invention is indium doped tin oxide coated PET (PET-ITO).

Said substrate suitably has a thickness of between 0.01 mm to 10 mm, more preferably between 0.1 mm to 5 mm.

Suitably several layers of the composition are coated or printed on the substrate. The number of layers should be sufficient to cover the surface of the substrate evenly but the total thickness of the composition on the substrate should not be so great that the bleaching time increases to an unacceptable level.

More suitably, said substrate comprises between 2-12 layers, still more suitably 3-10 or 3-8 layers and most suitably 3-5 layers of the composition.

In a further preferred embodiment of the invention the total thickness of the combined layers of the coating as defined by Atomic Force Microscopy is suitably in the region of 100-500 nm, suitably 200-400 nm, for example about 300 nm.

According to an aspect of the invention there is provided a method for preparing a coated or printed substrate, preferably a coated substrate, said method comprising the steps
i) Providing the dispersion or solution according to the invention
ii) Applying the dispersion or solution onto the substrate using a suitable coating or printing method; and
iii) Removing the solvent.

In a preferred method of the invention suitable coating or printing methods are selected from the group consisting of spray coating, dip coating, screen, inkjet printing, rotogravure, knife-coating, and slot-die coating, preferably from the group consisting of spray coating, dip coating, screen and inkjet printing.

Suitably the preferred method is spray coating. In order to accelerate the removal of the solvent, the substrate is typically heated at a temperature of between 30-50° C., more preferably 40° C. during and/or immediately after the coating or printing process.

According to an aspect of the invention there is provided an electrochromic device comprising a coated or printed substrate, preferably a coated substrate, according to the invention.

An electrochromic device consists of an electrochromic and an electroreactive layer separated by an electrolyte layer and sandwiched by two electrodes of opposite charge.

In a preferred embodiment of the invention said electrochromic device comprises electrodes and/or counter electrodes formed from a coated or printed substrate according to the invention.

The electrochromic devices of the invention typically undergo between 3000-1 million switching cycles, more preferably at least 10000, and even more preferably at least 40000 and even more preferably at least 100000 switching cycles before substantial degradation of the polymer coating deposited on the substrate occurs.

Suitably, said electrochromic device has a switching time below 0.9 mili seconds, suitably between 0.2-0.9 mili seconds More suitably, said electrochromic device has a switching time of 300 micro seconds.

In a preferred embodiment of the invention said electrochromic device has a bleaching time below 16 seconds, e.g. 15, 14, 13, 12, 11, 10, 9, 8, 7, 6, 5, 4, 3, 2 or 1. seconds, suitably for example between 0.1-2 seconds, and even more suitably between 0.25-1.75, 0.5-1.5 or 0.75-1.25 seconds.

Suitably, said electrochromic device has coloration efficiency of from 50-1100 cm²C⁻¹, more suitably from 55-800 cm²C⁻¹, 60-500 cm²C⁻¹ or 65-250 cm²C⁻¹.

Even more suitably said electrochromic device has coloration efficiency of from 70-110 cm²C⁻¹

According to an aspect of the invention there is provided a product comprising the electrochromic device of the invention. Examples of products which make use of electrochromic devices include windows, displays, monitors, sun shades, mirrors, wearable objects, furniture, toys, packaging, labels, documents etc.

According to an aspect of the invention there is provided an electrochromic ink comprising a dispersion or solution according to the invention.

In a preferred embodiment of the invention the ink comprises one or more further components selected from the group consisting of a liquid carrier, a dye or pigment and a resin.

The ink may be suitable for printing using any type of printer, but will typically be adapted for use with an inkjet printer or screen printer.

According to an aspect of the invention there is provided a method for forming a printed device comprising a printed pattern on a substrate, the method comprising depositing an ink according to the invention onto the substrate, suitably using a printer such as an inkjet printer.

In a preferred embodiment of the invention the substrate is conductive.

The invention will now be described in greater detail with reference to the drawings and to the examples.

### FIGURES

FIG. 1. a) Schematic representation of a traditional dual polymer transmission ECD (not to scale). b) Structure of copolymer 1.

FIG. 2. Schematic representation of the synthesis of the monomers 2 and 3 and the copolymer 1 FIG. 3. a) Schematic illustration of the preparation of the blending copolymer 1 and MWCNTs. b) Picture of the dispersion copolymer 1 and MWCNT (≈7.5%) in toluene/CHCl₃ (1:5, v/v) after a week from the preparation. Homogeneity tests of the drop coated solution on PET with a mixture of copolymer 1 and MWCNT (≈7.5%) in c) pure CHCl₃ and d) in toluene/CHCl₃ (1:5, v/v).

FIG. 4. Schematic representation of the coating of the blend solution on PET surfaces, depending on the percentage of MWCNTs and on the number of layers coated on the surface

FIG. 5. SEM pictures of a) 7 layers of solution of copolymer 1 coated on PET and different layers of mixtures of copolymer 1+0.75 mg MWCNT: b) 7 layers and c) 1 layer.

a) FIG. 6. TEM analysis of the blends coated on the metallic grid. b) Table 1. XPS analysis of the elements C, O, S of 9 layers of the copolymer 1 and blends coated by spray on PET.

FIG. 7. Plot of the average of the thickness of the films depending on the number of layers. The average is calculated taking in account the values of the height at the maximum value of numbers of events in the TM-AFM measurements.

FIG. 8. First Cyclic Voltammetry of copolymer 1 in PET-ITO electrode in red, in black the copolymer 1 with ≈7.5% of MWCNT in PET-ITO electrodes. Scan rate was 20 mV/s vs. Ag/AgCl reference. At least 4 wave peaks are observed. The presence of CNT seems to influence mainly the oxidation occurring circa 1.5 V.

FIG. 9. (a) Schematic representation of a traditional dual polymer transmission ECD (not to scale). (b) Picture of the real assembled ECD, containing the copolymer 1 with the addition of 10% of MWCNTs.

FIG. 10. AA when different voltages are applied on the device a) without and b) with MWCNT (7.5% w).

FIG. 11. Switching cycles for assembled electrochromic devices.

FIG. 12. Cycling performances of assembled electrochromic devices (a) without MWCNTs and (b) with 7.5% of MWCNT in L*a*b color space. (c) Trend of the T during the ON-OFF process of the cycles after the first cycles and 16.000 cycles of the device without MWCNTs (brown and red line) and the device with the addition of 7.5% MWCNTs (black and grey line). (d) ΔE versus the number of cycles depending on the percentage of MWCNT added during the formulation of the blend

FIG. 13. WCA measurements of a) copolymer 1 and b) mixture copolymer 1+0.75 mg MWCNTs coated on PET.

FIG. 14. Plot of the average roughness (Ra) and root mean square roughness (Rq) depending on the number of layers of the films of the solution of copolymer 1 with (0.75 mg, =7.5% w) and without the MWCNTs.

FIG. 15. Plot of the number of the events depending the height of the particles in the case of 1 layer of the blend is coated on the PET surfaces.

FIG. 16. Cyclic of 9 layers of blends on PET-ITO for different percentages of MWCNTs: a) 0%, b) 2.5%, c) 5.0% and d) 10.0%. Ag/AgCl was used as the reference electrode, a platinum wire as the counter electrode and the electrolytic solution was LiClO₄ (0.1M) in propylene carbonate. The cyclic voltammetry measurements were performed with a scan rate of 20 mV/s from −1.5V to 2V during 6 cycles.

FIG. 17. Synthesis of the copolymer 4.

FIG. 18. Cyclic voltammetry measurements of 9 layers spray coated on PET-ITO of copolymer shown without the pyrene moiety and MWCNTs (7.5%). Ag/AgCl was used as the reference electrode, a platinum wire as the counter electrode and the electrolytic solution was LiClO₄ (0.1M) in propylene carbonate. The CV measurements have been performed with a scan rate of 20 mV/s from −1.5V to 2V during 6 cycles.

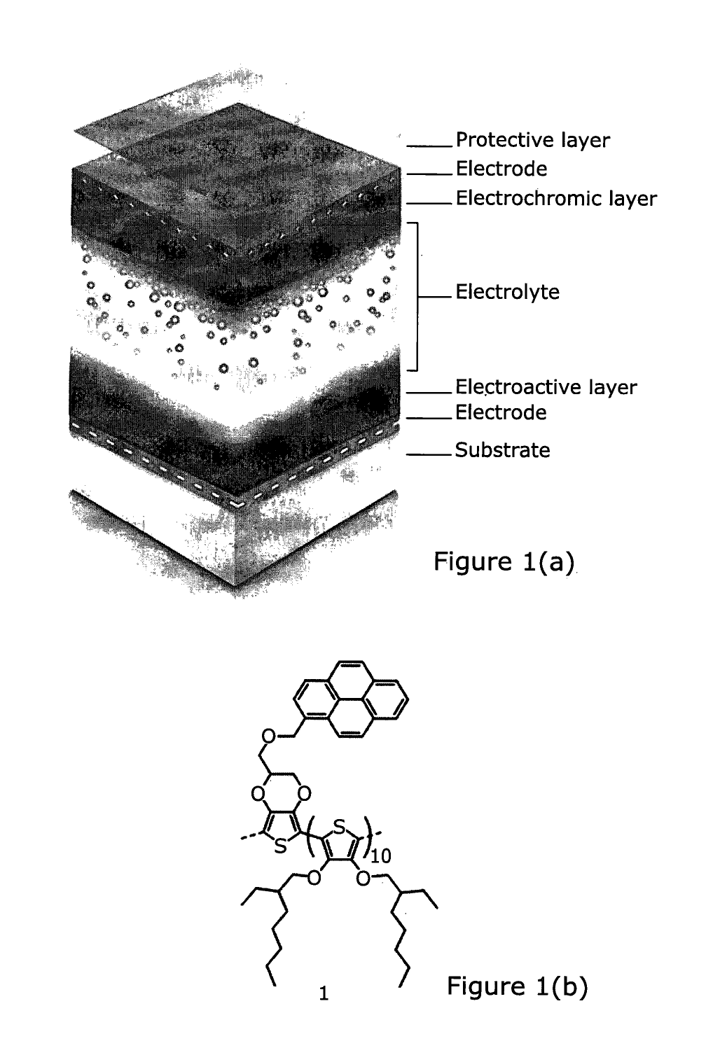

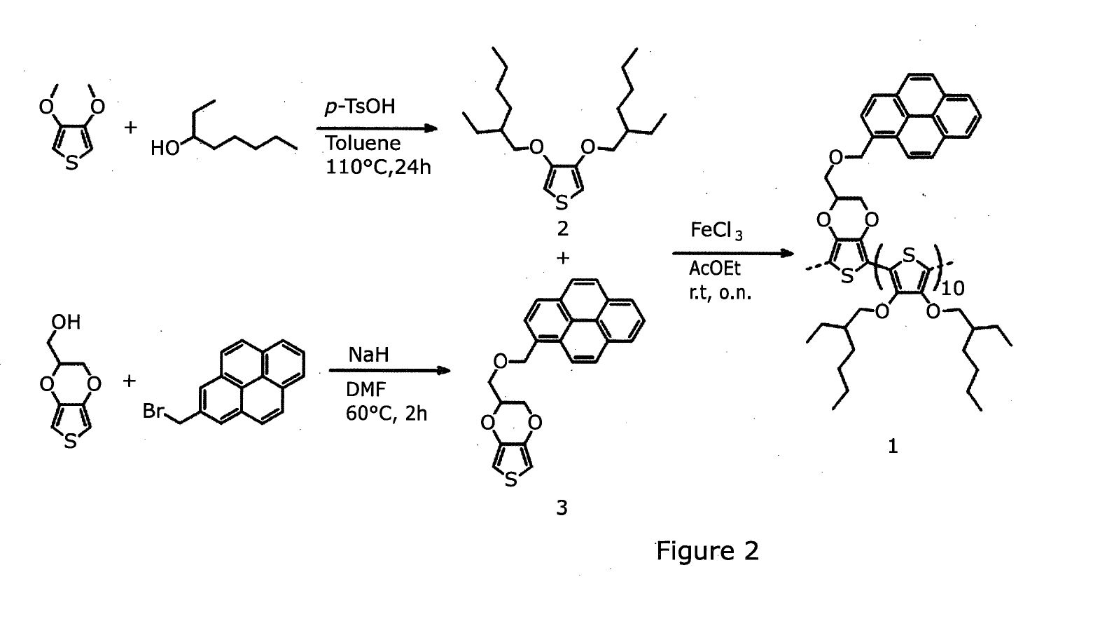

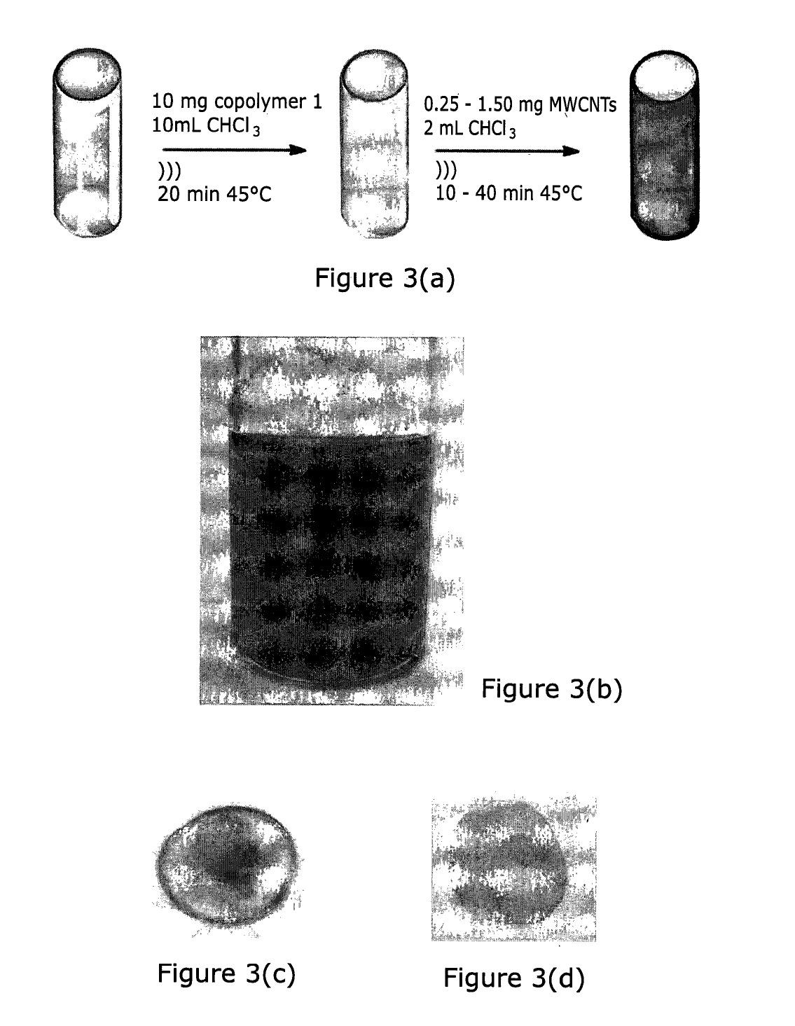

### Materials and Methods

Thin Layer Chromatography (TLC) was conducted on pre-coated aluminum sheets with 0.20 mm Machevery-Nagel Alugram SIL G/UV254 with a fluorescent indicator UV₂₅₄. Column chromatography was carried out using Merck Gerduransilica gel 60 (particle size of 40-60 m).

Melting points (m.p.) were measured on a Büchi Melting Point B-545 in open capillary tubes and have not been corrected.

Infrared spectra (IR) were recorded on PerkinElmer Spectrum Two.

Nuclear magnetic resonance (NMR)¹H and ¹³C spectra were obtained on a 400 MHz NMR (Jeol JNM EX-400) for experiment at room and high temperatures. Chemical shifts were reported in ppm according to tetramethylsilane using the solvent residual signal as an internal reference (CDCl₃: δ_{H}=7.26 ppm, δ_{C}=77.16 ppm). Coupling constants (J) were given in Hz.

Resonance multiplicity was described as s (singlet), d (doublet), dd (doublet of doublets), m (multiplet) and broad (broad signal). Carbon spectra were acquired with a complete decoupling for the proton.

Mass spectrometry was performed by the Centre de spectrométrie de masse at the Université de Mons in Belgium where they performed ESI-MS and MALDI-MS, on using the following instrumentation. ESI-MS measurements were performed on a Waters QToF2 mass spectrometer operating in positive mode. The analyte solutions were delivered to the ESI source by a Harvard Apparatus syringe pump keeping the reaction at a flow rate of 5 L/min. Typical ESI conditions were, capillary voltage 3.1 kV; cone voltage 20-50 V; source temperature 80° C.; desolvation temperature 120° C. Dry nitrogen was used as the ESI gas. For the recording of the single-stage ESI-MS spectra, the quadrupole (rf-only mode) was set to pass ions from 50 to 1000 Th, and all ions were transmitted into the pusher region of the time off-light analyser where they were mass analysed with 1 s integration time. MALDI-MS were recorded using a Waters QToF Premier mass spectrometer equipped with a nitrogen laser, operating at 337 nm with a maximum output of 500 mW delivered to the sample in 4 ns pulses at 20 Hz repeating rate. Time of-flight analyses were performed in the reflectron mode at a resolution of about 10,000. The matrix solution (1 μl) was applied to a stainless steel target and air dried. Analyte samples were dissolved in a suitable solvent to obtain 1 mg/mL solutions. 1 μl aliquots of those solutions were applied onto the target area already bearing the matrix crystals, and air dried. For the recording of the single-stage MS spectra, the quadrupole (rf-only mode) was set to pass ions from 100 to 1000 Th, and all ions were transmitted into the pusher region of the time-of-flight analyser where they were analysed with 1 s integration time

Scanning electron microscopy (SEM) images were obtained on a JEOL 7500F. The films at different percentage of MWCNTs and different number of layers, were spray-coated on PET, then a layer of 10 Å thick of metal Gold was coated by using a JEOL JFC-1300.

Transmission electron microscopy (TEM) images were obtained using the SEM microscope JEOL 7500F using the TEM mode. The blend was spray coated on the metal grid for TEM, CF200-Cu CARBON FILM on 200 Square Mesh Cupper Grid provided by Electron Microscopy Sciences.

Water contact angle (WCA) measurements were performed using a CA-A contact angle meter (Kyowa Scientific Company Ltd, Japan) at ambient temperature. Water droplets (0.2 mL) were dropped carefully onto the surface. The average WCA value was determined by measuring at three different positions of the same sample, and their images were captured with a traditional digital camera (Sony).

Profilometry of the layers coated on PET was investigated using a Surface Profile Measuring System Dektak 8 from Veeco Instruments.

X-ray photoelectron spectroscopy (XPS) characterization was performed with a SSX-100 system (Surface Science instrument). The photon source was a mono chromatized Al Kα line (hv=1486.6 eV) applied with a take-off angle of 35°. In the spectrum analysis, the background signal was subtracted by Shirley's method. The C level peak position of carbon atoms was taken as the reference at 284.5 eV, when for O and S the reference was respectively at 533 eV and 162 eV. The spectrum analysis was carried out by fitting the peak shape obtained in the same analysing conditions and other components with mixed (Gaussian+Lorentzian) line shapes. XPS atomic ratios have been estimated from the experimentally determined area ratios of the relevant core lines, corrected for the corresponding theoretical atomic cross-sections and for a square root dependence of the photoelectrons kinetics energies.

Cyclic voltammetry (CV) measurements were performed in a conventional three-electrode cell. The blend deposited by spray-coating on a PET-ITO electrode was the working electrode, a platinum wire was used as the counter electrode, an Ag/AgCl electrode was the reference electrode, and the supporting electrolyte was a solution of propylene carbonate with lithium perchlorate salt (0.1 M).

UV-vis absorbance spectra and spectroelectrochemical measurements of the copolymer and copolymer/CNT devices were performed using an UV-vis spectrophotometer Cary 300 Bio (spectral range from 351 to 800 nm). On the spectroelectrochemical measurements the applied potential to the devices were controlled with a potentiostat Autolab PGSTAT 100N. The devices were placed in the spectrophotometer compartment perpendicularly to the light beam. The potentiostat applied a continuous electric potential (at selected values), and the spectrophotometer registered the absorbance spectra within the range of the equipment.

Cycling experiments were performed using a camera equipped by a diffuse lamp to control the luminosity (ML series Cold-Cathode Light Panel from Vision Light Tech), and a colour Checker (colour pattern). The electrochromic devices were placed inside the chamber and connected to a function generator. While the function generator applied a determined potential in a square waveform (changing from positive to negative), the camera was setup to record, from time to time, 150 pictures during a calculated period of time, enough to see a complete cycle of the device oxidation and reduction (during several hours, days, or weeks depending on the durability of the device). The pictures were then treated with Matlab software to convert the RGB coordinates obtained from the images into L*a*b* coordinates.

### Chemicals

Chemicals were purchased from Sigma Aldrich, TCI and ABCR and were used as received. Solvents were purchased from Sigma Aldrich, and deuterated solvents from Eurisotop. Solvents for spectrophotometry was purchased from Acros Organics and Jansen Chemicals.

### Synthetic Strategy

### Synthesis of 3,4-bis((2-ethylhexyl)oxy)thiophene (DMT Monomer), 2

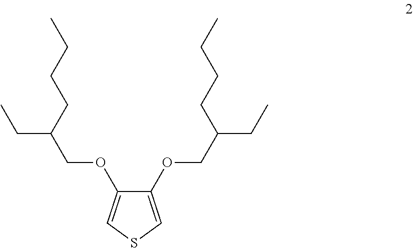 [SMILES: CCCCC(CC)COc1cscc1OCC(CC)CCCC]

3-4 dimethoxythiophene (1442 mg, 10.0 mmol), 2-ethylhexanol (5470 mg, 42.0 mmol) and p-toluene sulfonic acid (230.3 mg, 1.0 mmol) were dissolved in toluene (50 mL) under inert atmosphere and the mixture was stirred at 110° C. for 24 hours. The reaction was degassed each 3 hours to release methanol. The solution was cooled at room temperature, the organic phase was washed with water (3×25 mL) and dried over Na₂SO₄. The organic solvent was evaporated in vacuo and the crude was purified by silica gel column chromatography (eluent: benzene), affording 2 as pale yellow oil (92% yield, 3133 mg).^{[281]}

M. f.: C₂₀H₃₆SO₂. IR (NaCl disks): v (cm⁻¹)=3649, 2927, 2360, 1844, 1558. ¹H-NMR (400 MHz, CDCl₃): δ (ppm) 0.92 (m, 12H), 1.19-1.65 (m, 16H), 1.76 (m, 2H), 3.85 (d, 4H, J=5.9 Hz), 6.17 (s, 2H). ¹³C NMR (100 MHz, CDCl₃): δ (ppm) 148, 96, 73, 39, 30, 29, 24, 23, 14, 11.

### Synthesis of 2-((pyren-1-ylmethoxy)methyl)-2,3-dihydrothieno[3,4-b][1,4]dioxine (EDOT-Pyrene Monomer) 3

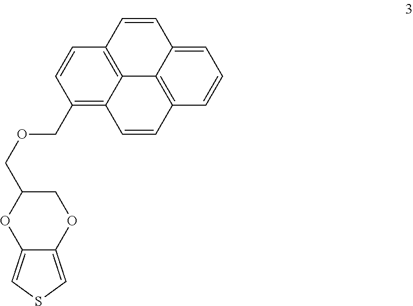 [SMILES: c1cc2ccc3ccc(COCC4COc5cscc5O4)c4ccc(c1)c2c34]

A dispersion of NaH (60% in mineral oil, 390.0 mg, 9.75 mmol) and 2,3-dihydrothieno[3,4-b]-1,4-dioxin-2-methanol (960.9 mg, 5.58 mmol) in anhydrous DMF (20 mL) under argon was heated at 60° C. for 30 minutes, and 1-bromomethylpyrene (2021 mg, 6.85 mmol) was added, the mixture was stirred for 2 hours at 60° C. Afterwards, the solvent was evaporated in vacuo and the crude was purified by silica gel column chromatography (eluent: n-hexane/AcOEt 8:1), affording an yellow powder. Finally, the powder was solubilized in CH₂CL₂ and precipitated using MeOH affording 3 as yellow-greenish powder (80% yield, 1.73 g).

M. f.: C₂₄H₁₈SO₃. m. p.: 120.4-122.2° C. IR (powder): v (cm⁻¹)=2913, 2200, 2152, 2031, 1470, 1186, 1029, 908, 842, 776, 709. ¹H-NMR (400 MHz, CDCl₃) δ (ppm): 3.73-3.85 (m, 2H), 4.03-4.08 (m, 1H), 4.19 (dd, 1H, J₁=12 Hz, J₂=8 Hz), 4.32-4.38 (m, 1H), 5.30 (d, 2H, J=4 Hz), 6.33 (dd, 2H, J₁=12 Hz, J₂=4 Hz), 8.02 (dd, 2H, J₁=16 Hz, J₂=8 Hz), 8.07 (d, 2H, J=4), 8.14 (d, 1H, J=4 Hz), 8.16 (d, 1H, J=4 Hz), 8.21 (dd, 2H, J₁=12 Hz, J₂=8 Hz), 8.37 (d, 1H, J=8 Hz). ¹³C NMR (100 MHz, CDCl₃): δ (ppm) 66.3, 68.3, 72.5, 72.8, 99.8, 99.9, 123.4, 124.6, 124.8, 125.1, 125.5, 125.5, 126.2, 127.3, 127.5, 127.8, 128.1, 129.6, 130.6, 130.9, 131.4, 131.7, 141.6, 141.7. HRMS (EI+): 386.0977 ([M]⁺ 386.4640 calculated for [C₂₄H₁₈SO₃]+).

### Synthesis of Copolymer EDOT-Pyrene/DMT (1:10), 1

A solution of FeCl₃ (1217 mg, 7.50 mmol) in AcOEt (10 mL) was slowly added into a solution of (±)-62 (50.2 mg, 0.13 mmol) and 64 (388.2 mg, 1.14 mmol) in AcOEt (10 mL). The mixture was stirred at room temperature overnight, then MeOH (50 mL) was added to quench the reaction. The mixture was filtered and washed with MeOH till the waters were clear. The resultant dark powder was dissolved in 10.0 mL of CHCl₃ and hydrazine (2.0 mL) was added dropwise into the solution. The mixture was concentrated in vacuo to around 10 mL and precipitated by addition of MeOH (100 mL). The solution was stirred for 10 minutes and then filtered. The precipitate was re-dissolved in 20 mL of CHCl₃, re-precipitate using MeOH (150 mL) and re-filtered affording 59 as dark orange powder (42% yield).^{[281]m. p.: degradation before melting around} 275° C. IR (powder): v (cm⁻¹)=2957, 2925, 2860, 2149, 1745, 1456, 1363, 1221, 1015, 853, 781, 721. ¹H NMR (400 MHz, CDCl₃) δ (ppm) (ppm) 2.4 (m, 2H), 5.4 (s, 2H).

### Wettability of the PET Surfaces.

Table 1 reports the WCA values of the PET surfaces after a treatment with organic solvents. The mixture with Toluene/CHCl₃ 1:5 v/v provides the lowest values of WCA that guarantee a good deposition of the blend on the plastic surface.

TABLE 1
Values of the contact angles of
different solvents measured on PET.

| Solvent | Contact angle (°) |
|---|---|
| Toluene | 14 |
| DMF | 16 |
| Acetonitrile | 30 |
| THF | 12 |
| Ethyl Acetate | 8.5 |
| Toluene/CHCl₃ 1:1 | 11 |
| Toluene/CHCl₃ 1:5 | 8 |

### Conductivity of the Drop-Coated Solutions on PET

The values of the resistivity (measured in MO) of the drop-coated solutions on PET after the preparation of the blends are reported in Table 2 and can be used as indicator of the conductivity of the films.

TABLE 2
Resistivity of the drop-coated on PET of solutions
for different percentages of CNT.

| Amount of MWCNTs | |
|---|---|
| in solution (%) | Resistivity (MΩ) |
| 0.0 | Not conductive |
| 2.5 | 50-130 |
| 5.0 | 10-50 |
| 7.5 | 8-20 |
| 10.0 | 1.4-1.5 |
| 12.5 | 0.11-1.10 |
| 15.0 | 0.07-0.12 |

### WCA Measurements for the Homogeneity of the Films

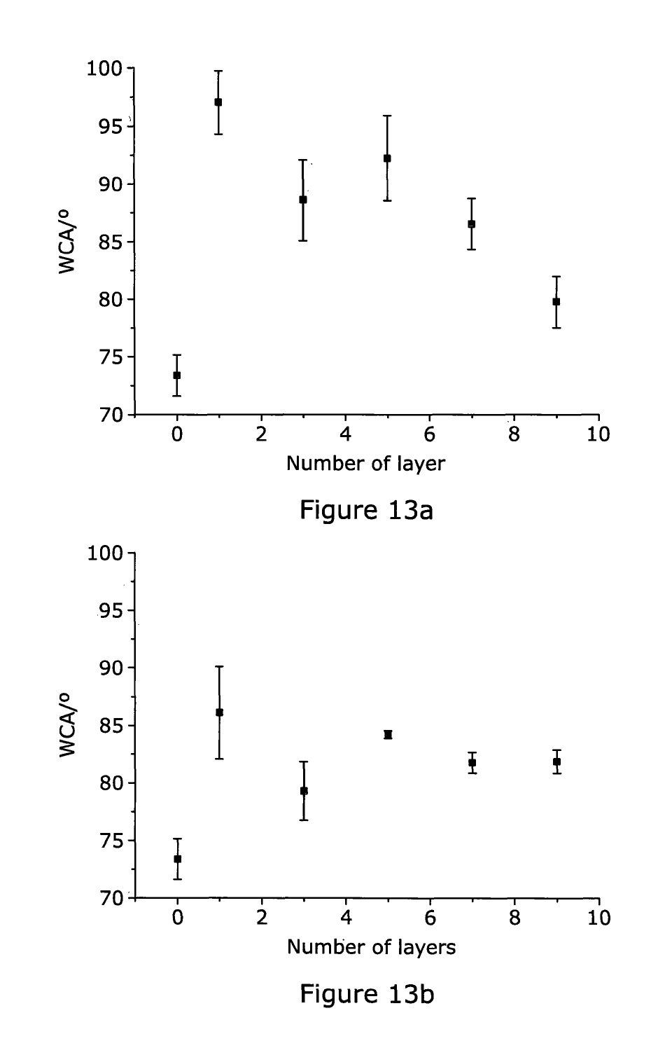

The analysis of the films by WCA is used to determine their homogeneity depending on the number of the layers and on the percentage of the MWCNTs used for the blends. FIG. 13(a) shows the trend of the WCA analysis of the films without MWCNTs, while FIG. 13(b) illustrates the results obtained for the measurement with 7.5% w of MWCNTs. The plotted values are respectively reported in Table 3 and Table 4.

TABLE 3
WCA measurements of the films of the copolymer 1
coated on PET, values plotted in FIG. 13(a)
WCA of films of copolymer 1

| Number of layers | average | Deviation standard |
|---|---|---|
| 0 layers (PET surface) | 73.35 | 1.78 |
| 1 layer | 97.03 | 2.73 |
| 3 layers | 88.60 | 3.50 |
| 5 layers | 92.23 | 3.68 |
| 7 layers | 86.53 | 2.21 |
| 9 layers | 79.73 | 2.25 |

TABLE 4
WCA values of the films of the blend containing the 7.5% of
MWCNTs coated on PET, which are plotted in FIG. 13(b).
WCA of films of copolymer 1 + 0.75 mg MWCNTs

| Number of layers | average | deviationstandard |
|---|---|---|
| 0 layers (PET surface) | 73.35 | 1.78 |
| 1 layer | 86.07 | 4.01 |
| 3 layers | 79.27 | 2.54 |
| 5 layers | 84.23 | 0.32 |
| 7 layers | 81.75 | 0.92 |
| 9 layers | 81.83 | 1.00 |

### Roughness of the Films

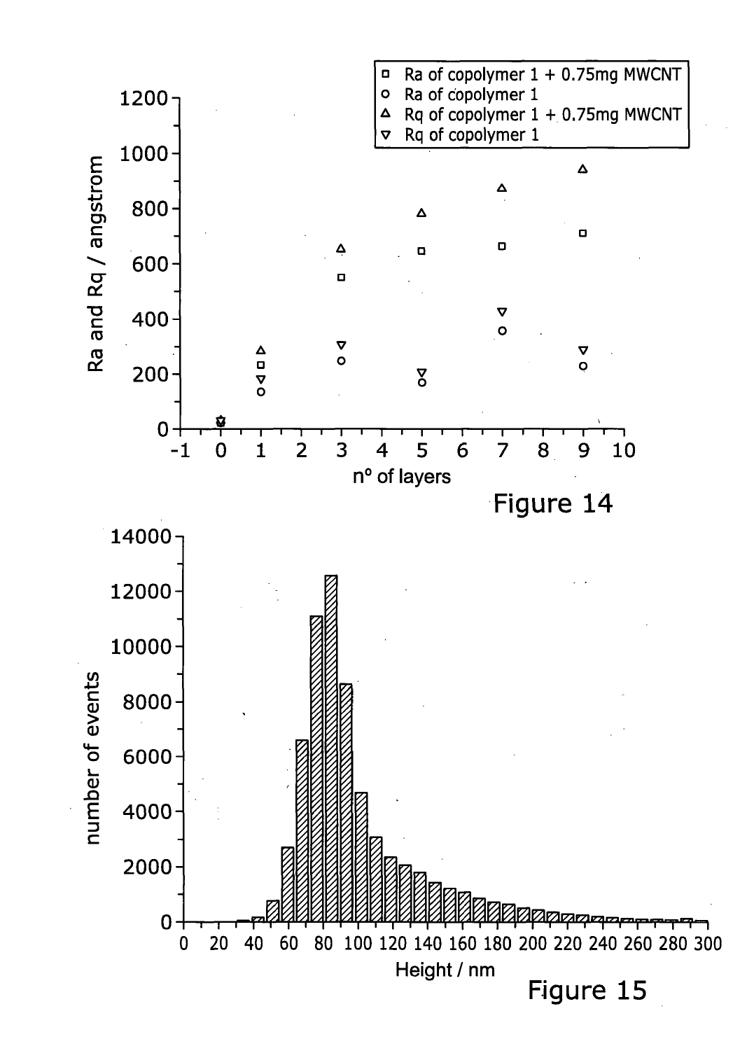

The average roughness (Ra) and root mean square roughness (Rq) of the films without and with the 7.5% of MWCNTs have been measured by using a profilometer as measurement of their roughness. FIG. 14 illustrates a randomly distribution of the values in the case of the films without MWCNTs. When 7.5% w of MWCNTs are added, the Ra and Rq seem to reach a plateau depending on the number of layers coated on the surface.

### Thickness Measured by AFM

FIG. 15 shows the Gaussian plot of the number of events depending on the height of the films, in the case where only one layer of blend is coated on the PET surface. The surface for the measurements has been prepared following the procedure described in the manuscript.

### Cyclic Voltammetry at Different Percentages of MWCNTs

is coated on the PET surfaces.

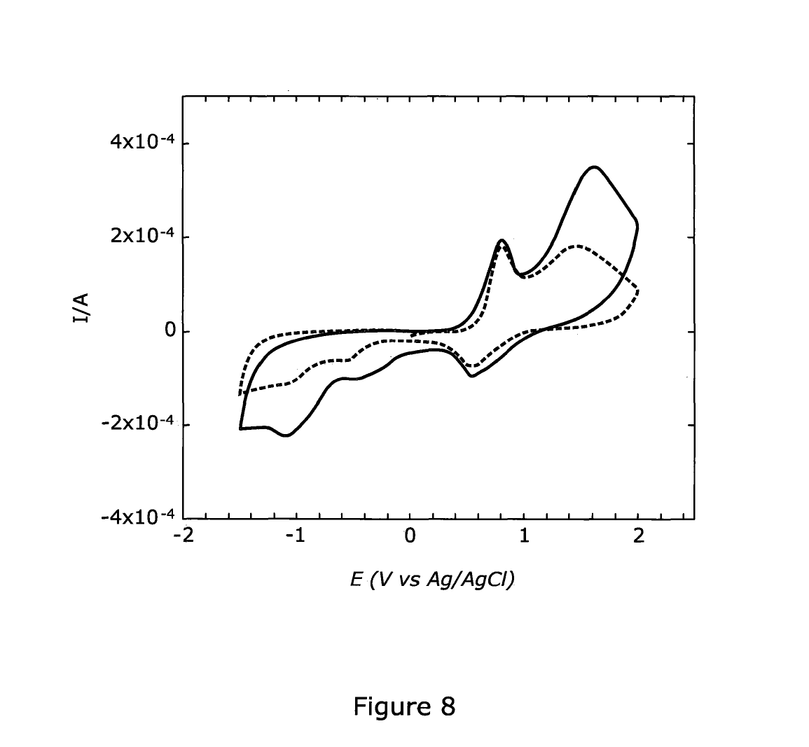

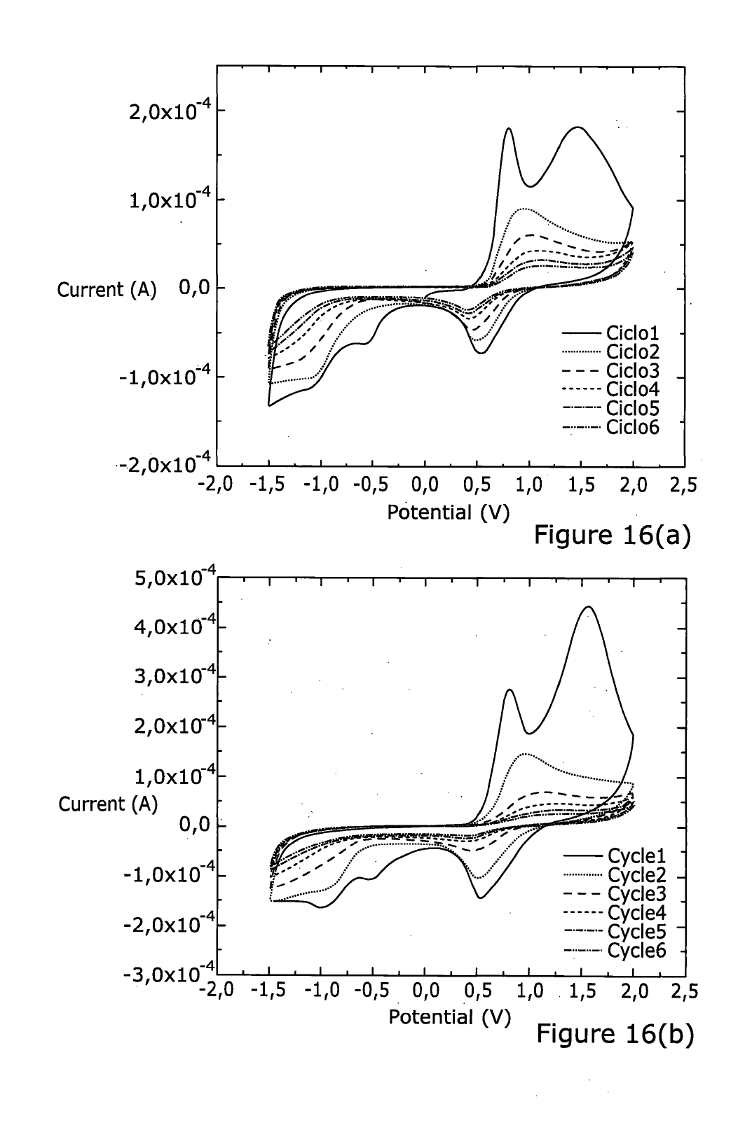

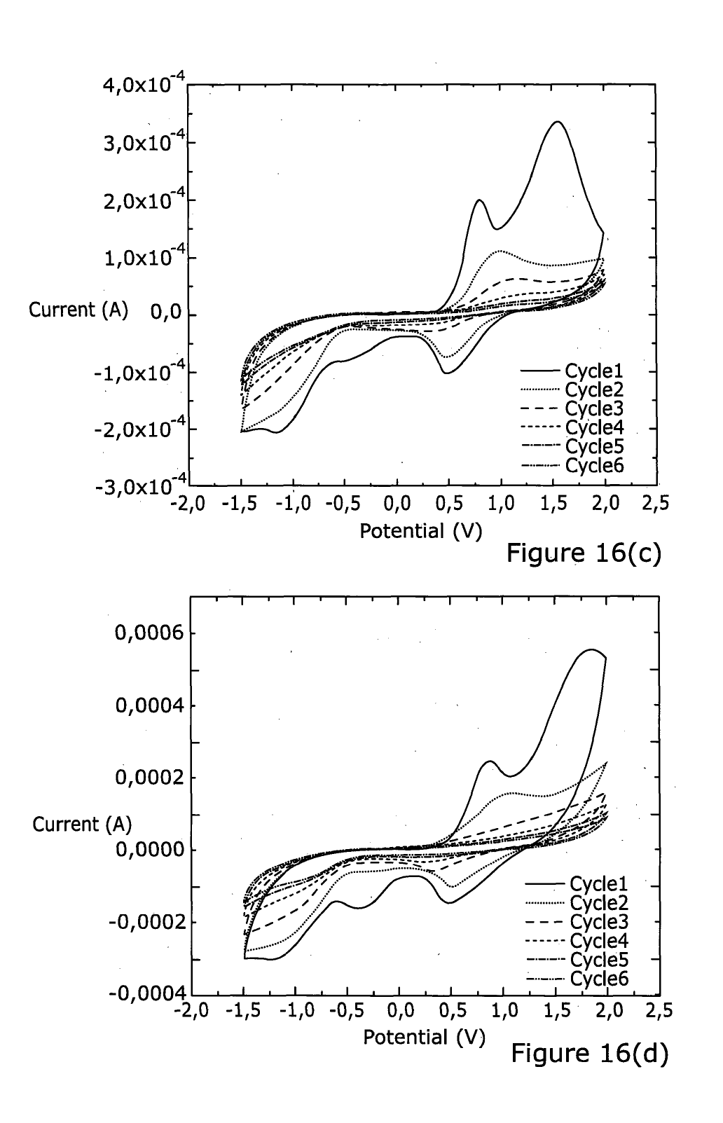

FIG. 16 illustrates the cyclic voltammograms obtained for the films containing different percentages of MWCNTs. The peak at 1.5 V, registered in FIG. 8 of the manuscript, shifts at higher values of Potential (V) and Current (A) depending on the percentage of MWCNTs.

### Synthesis of the Copolymer 4 and its Cyclic Voltammetry

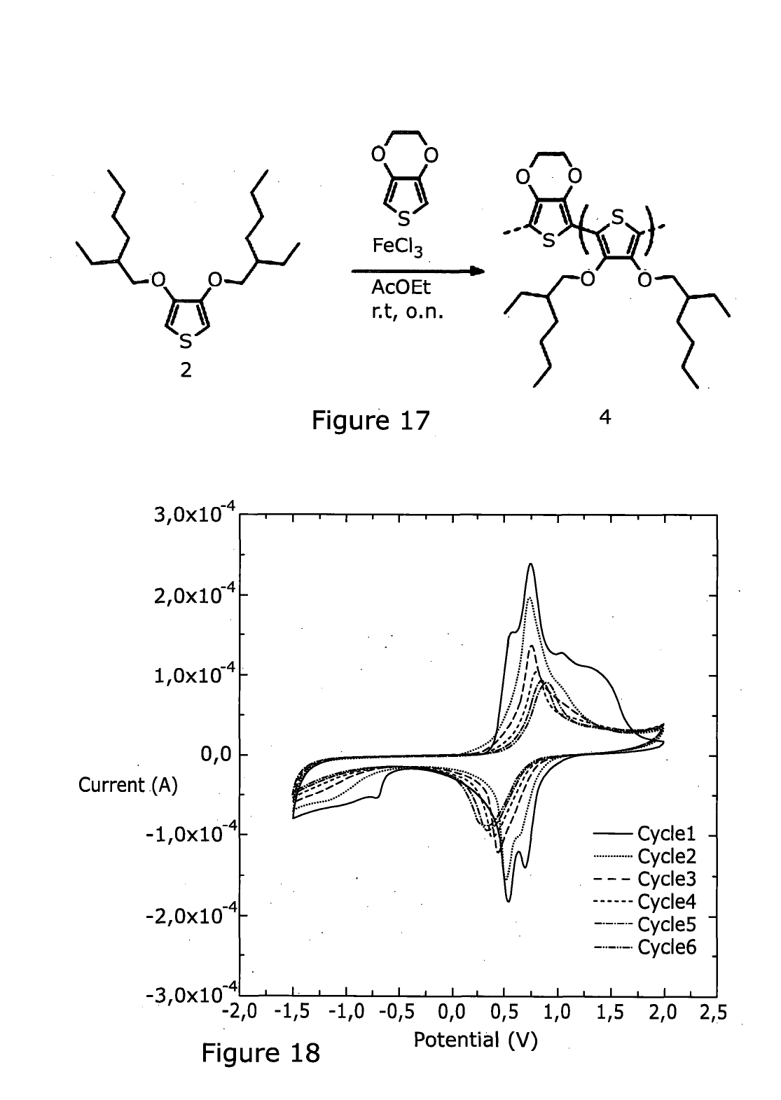

The procedure related to the synthesis of the copolymer 4 is sketched in FIG. 17.

The resulting new copolymer has been dissolved in a mixture of chloroform-toluene in a ratio 5:1 and has been then spray-coated on PET-ITO to form a uniform orange-pink film. The plot sketched in FIG. 18 shows as expected only one cathodic peak from the thiophene unit. This confirms that the second cathodic peak observed in the pyrene-appended voltammogram comes from the pyrene moiety. This also proves that the shift observed for the second cathodic peak in the voltammogram illustrated in FIG. 8 is due to the blend of the copolymer and the MWCNTs, and especially to the π-π interaction between the MWCNTs and the pyrene moiety.

### EXAMPLES

### Example 1

The synthesis of the copolymer 1 has been designed a priori taking in consideration the three peculiarities that the material has to possess i.e. be soluble in presence of MWCNT in organic solvents, be easy to deposit on the surface and the resulting films on PET-ITO have to be as colorless as possible. To achieve the first requirement, the main monomer contains two alkyl chains in the position three and four of the thiophene ring that is able to guarantee a good solubility in organic solvents, while the second monomer, the EDOT unit, is chemically bonded to the pyrene moiety. This latter is known to make a strong π-π interaction with MWCNTs with the assumption to induce the blending of the copolymer 1 in the carbonaceous material. The synthesis of the monomer 2 has been achieved in a good yield using the commercially available 3-4 dimethoxyltiophene, which was poured in toluene at the temperature of 110° C. for 24 hours in presence of a catalytic amount of p-toluene sulfonic acid and the tertiary alcohol 2-ethylhexanol.¹ The other monomer has been successfully obtained by performing a Williamson's etherification; NaH in mineral oil has been used for the deprotonation of the primary alcohol and the 1-bromomethyl pyrene has been added to the DMF solution, giving after 2 hours of reaction the desired product 3. The polymerization of the two monomers 2 and 3 has been induced by FeCl₃ in ethyl acetate with satisfactory yields (Dyer, A. L.; Craig, M. R.; Babiarz, J. E.; Kiyak, K.; Reynolds, J.; Macromolecules 2010, 43, 4460-4467).

### Example 2

While the resulting copolymer 1 is soluble in most of the common organic solvents, a challenge remains for obtaining a good blend with the MWCNTs (required for future applications), owing to the bad dispersability of the carbon nanostructure (Liu C. X., Choi J. W.; Nanomaterials, 2012, 2, 329-347) and the formation of smooth and homogeneous films. We have measured the solvent contact angle of the PET surface after a treatment in organic solvents to allow the smoothest spreading of the ink on the surface (see Table 1). The optimal solvent mixture has been achieved using toluene/CHCl₃ (1:5, v/v), in which the measured contact angle is just 8°. Based on this value we have optimized the blends as follows: in a flat bottom vial of dimension 2*6.5 cm were added 10 mg of copolymer 1, 10 mL of CHCl₃ were added in two portions of 5 mL with sonication after each addition (10 minutes at 45° C.); almost all the copolymer is dispersed in the CHCl₃. The pristine MWCNTs were added in portion of 0.25 mg to check the limit of dispersability in the dark red solution with 2 mL of toluene. The solution is again sonicated during 5 minutes at 45° C. for each addition, producing a black-reddish solution in which the two components are well dispersed. Due to the darkness of the solution and the difficulties to define the presence of the sedimentation in the vial, the value of 1.50 mg of MWCNT has been considered as upper limit for the dispersability of the MWCNT in the chloroform solution of copolymer 1. In the other cases, between 0.25 and 1.25 mg of MWCNTs (corresponding to =2.5-12.5% w) no precipitates were observed over a week. FIG. 3(a) illustrates the blending procedure while FIG. 3(b) shows the picture of the solution after a week. As observed in the case of the mixture Toluene/CHCl₃ (1:5, v/v), we have been able to get stable solutions using other solvents, i.e. in CHCl₃ and THF. The drop casting test on PET of those solutions gave the possibility to observe the most homogenous film and also to perform a qualitative measurement of the resistivity by using a multimeter. The drop-casted samples of the solutions of blends containing 1 and p-MWCNTs gave the possibility to observe the most homogenous film and also to perform a qualitative measurement of the resistivity by using a multimeter. The best homogeneity is observed in the case of the mixture Toluene/CHCl₃ (1:5, v/v) and these latter were the only conductive films on PET-ITO (between 8 and 20 nS/m).

### Example 3

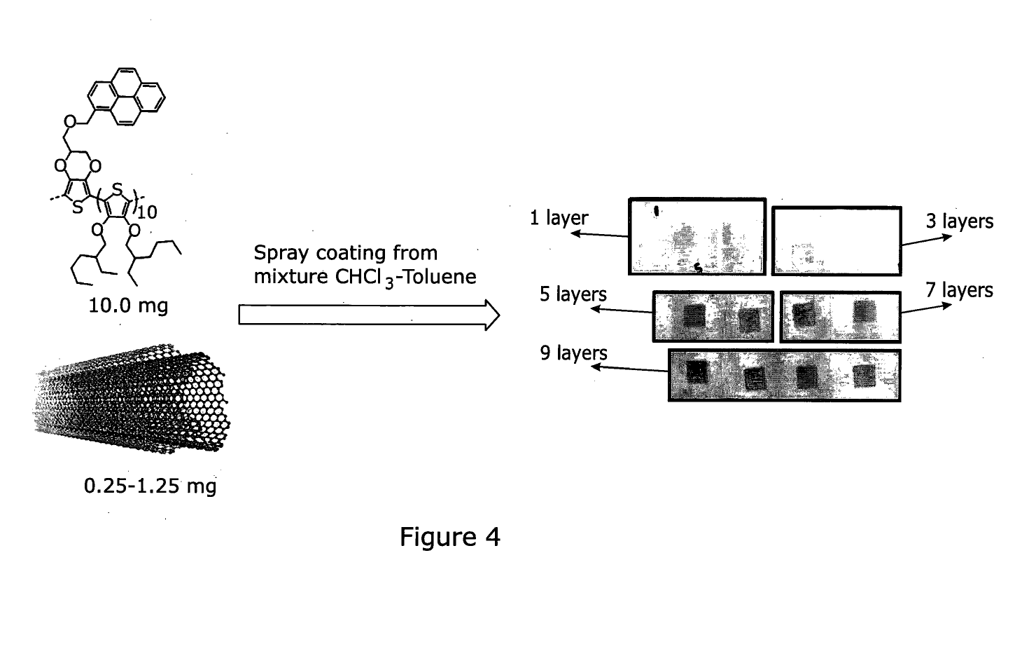

Due to both the versatility of the solutions containing the blend and the dimensions of the MWCNTs, the spray-coating has been chosen as technique for the coating of the solutions with and without MWCNTs on PET-ITO and/or PET. In order to accelerate the evaporation of the solvents, the surfaces have been placed on a hot plate at 40° C., allowing us to perform a systematical study of the optimal conditions to get the best device. FIG. 4 illustrates a schematic representation of the coating on PET surfaces. The amount of MWCNTs used for the blend and the number of the layers coated in the surface are the main variables considered during the systematical study, while the current applied in the device is the third variable taken under exam that is analyzed after the assembly of the device.

### Example 4

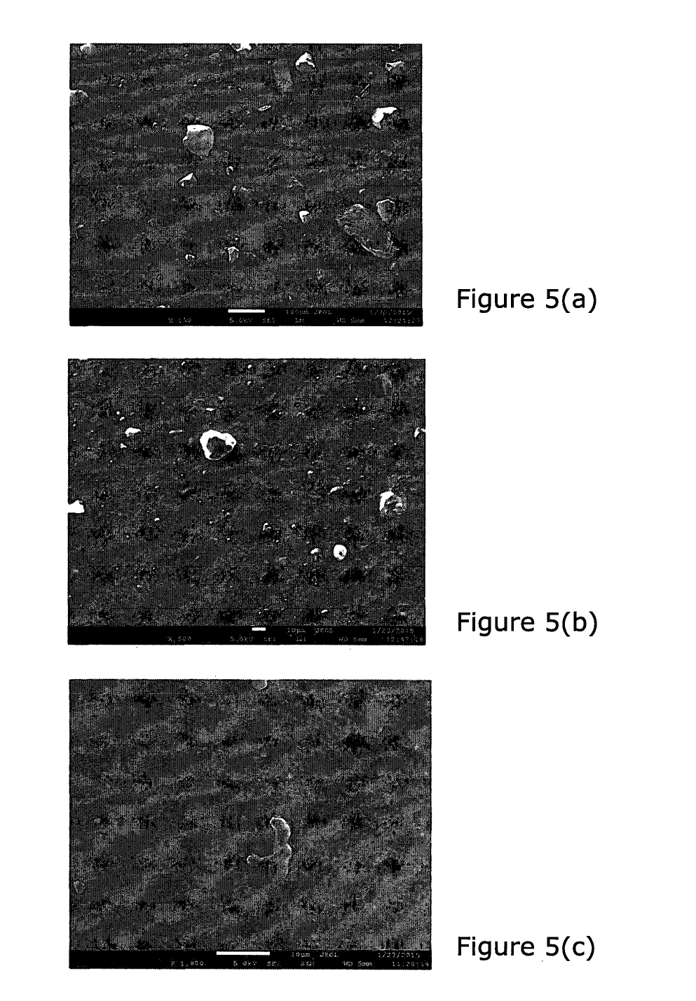

The solutions coated on PET-ITO have been characterized by several techniques to confirm the first considerations concerning the homogeneity of the films. From the first analysis with the SEM microscope, the MWCNTs seem to increase the dispersability of the copolymer 1 in the organic mixture. This synergic effect is observed in the pictures illustrated in FIG. 5(a-b), on which the number of layers are kept constant, and we have observed that the films coated on PET without MWCNTs present much more rocks on the surface. The number of layers also contributes to the homogeneity of the films. We have noted that the ones composed by only one layer of blend present holes and defects that can compromise the performances of the device (FIG. 5(c)), while by coating 7 layers of the blend (FIG. 5(b)), the surfaces are more homogenous.

### Example 5

The qualitative analysis made from the observations obtained with the microscope have been confirmed by the analysis of the WCA. Three tests on the same surface have been performed to get an average to be reported in a plot containing the values of the angles versus the number of layers. The standard deviation in our measurements is notably dramatically reduced after the coating of more than 3 layers of the blend copolymer 1-MWCNTs, indicating an increase in the homogeneity of the sample. In the cases of 5, 7 and 9 layers of the copolymer 1 coated on PET-ITO, the films have a standard deviation comprised between 2.21 and 3.68, while the addition of the carbonaceous material reduces it to 0.38 and 1.00. The decrease of the standard deviation is even more pronounced in comparison of the number of layers. Indeed, concerning the cases of 1 and 3 layers of the blend the values are respectively equal to 4.01 and 2.54, while as mentioned above, in the case of 5, 7 and 9 layers, the values are not higher than 1.00. FIG. 13 shows the plot of the WCA trends for the copolymer 1 and the blend with MWCNTs, while

Table and Table report the associated values. Moreover, the homogeneity of the films with 5, 7 and 9 layers of a mixture of copolymer 1+0.75 mg of MWCNTs is proven by using a profilometer. The trends of the Ra (average roughness) and Rq (root mean square roughness) seem to reach a plateau when 7 or 9 layers of the blend are coated on PET, while for the solution of copolymer 1, the two trends present a “random” disposition on the plot which is highlighted in FIG. 14 (see SI).

### Example 6

The presence of MWCNTs in the blend coated on the surfaces has been proven by performing Transmittance Electron Microscopy (TEM) and XPS analysis. a) FIG. 6 reports the result of the TEM analysis of the blends on the metallic grid, in which the presence of the carbonaceous material as one of the components of the films is unequivocal. Moreover, the analysis of the films constituted by 9 layers of the copolymer 1 and the blend on PET put clearly in evidence, the increase of the atom percentage of C and the decrease of O and S in the film with the addition of MWCNTs. The results are presented in Table 5.

TABLE 5
XPS analysis of the elements C, O, S of 9 layers of the
copolymer 1 and blends coated by spray on PET.

| % atom | Copolymer 1 | Copolymer 1 + 0.75 mg MWCT |
|---|---|---|
| C | 66.75 ± 14.70 | 86.15 ± 1.50 |
| O | 30.42 ± 13.76 | 12.51 ± 1.32 |
| S | 2.83 ± 0.96 | 1.33 ± 0.23 |

### Example 7

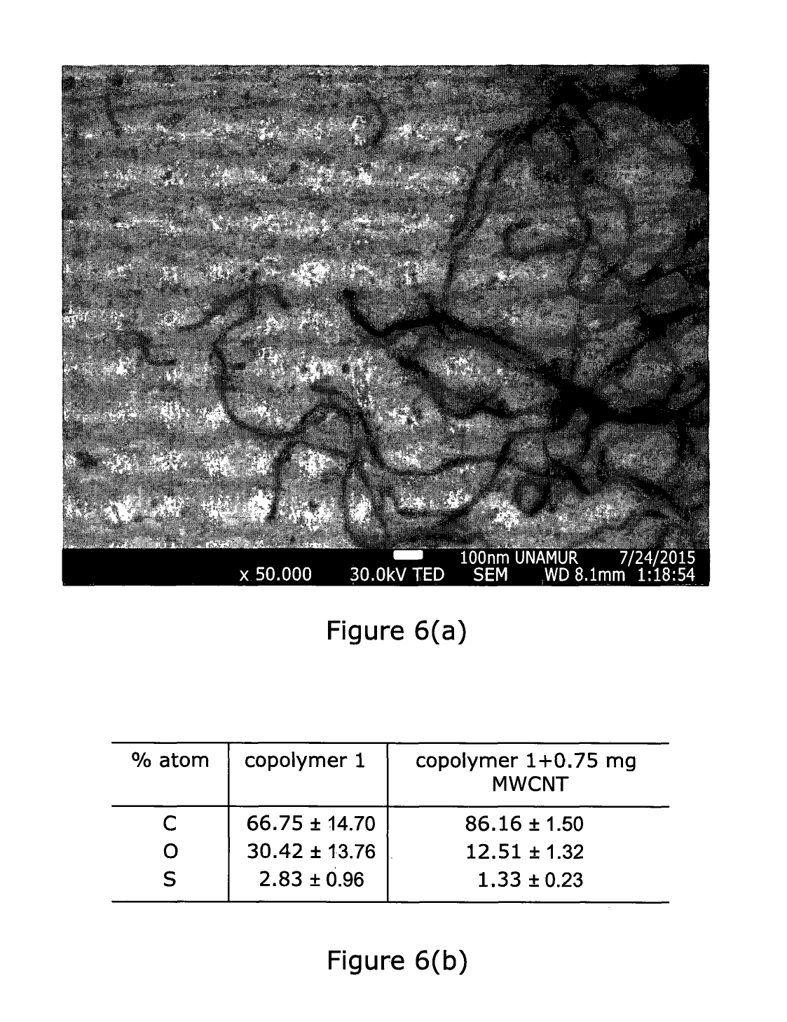

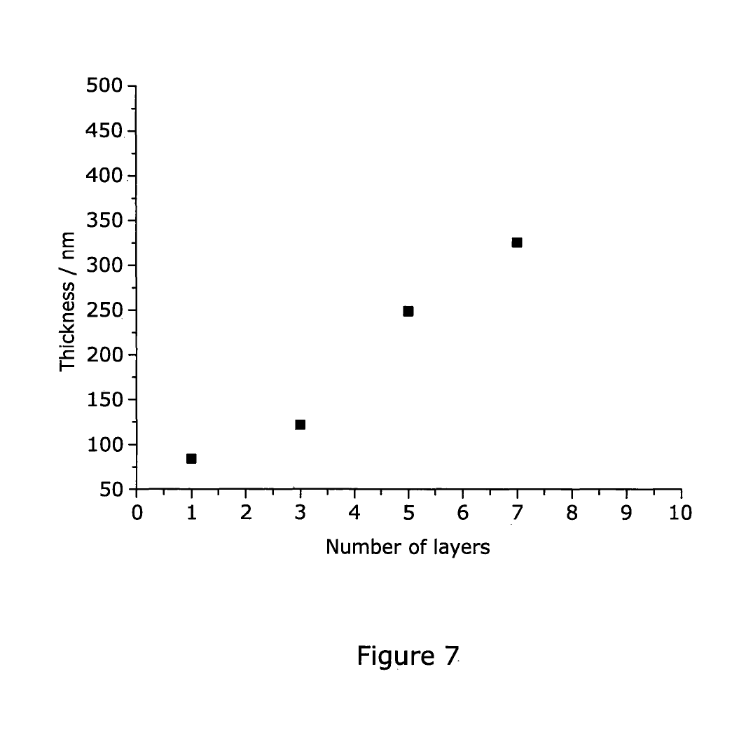

The thickness of the different number of layers has been defined by using Atomic Force Microscopy (AFM). A metallic plate spatula covered by a cotton wool, slightly wet with Acetone, has been used to clean a part of the surface containing the films with a sharp and firm pass, making a definite rut in the surface. The surfaces have been analyzed by using the TM-AFM technique in the border of the rut and it has been possible to determine a gaussian trend of the number of the events versus the height in the scale of nm. For each film, the average on three measurements of the height at the maximum value of the gaussian trend (corresponding to the thickness of the films) is plotted versus the number of layers coated, giving a line trend, as reported in FIG. 7.

### Example 8

The spray-coated thin-films over PET-ITO substrates have been characterized electrochemically. Cyclic Voltammograms showed several redox peaks with and without CNTs, and were dependent of the number of voltammogram cycles. In the first cycle (see FIG. 8), we observe 3 reduction and two oxidation peaks at 1.5 V and 1.0 V, this latter is the only peak that do not depend of the presence of CNTs (see also supplementary information). Due to the changes of coloration, the higher intensity of the peaks and the unexpected second oxidation peaks at 1.5 V, we were more interested in the study of the oxidation process. As already mentioned, the peak at 1.0 V does not depend on the percentage of MWCNTs, while is clear the trend that takes the peak at 1.5 V, this latter value increases in intensity and shifts at higher voltage values by the addition of MWCNTs. This peak has been assigned to the pyrene oxidation, after the cyclic voltammograms of the similar copolymer 4 devoid of the pyrene unit, which show the total absence of the peak at 1.5 V. The copolymer 4 is synthesized following the polymerization reaction induced by FeCl₃ in AcOEt, from the monomer 2 and the commercially available EDOT, synthetic scheme and cyclic voltammogram in the SI.

### Example 9

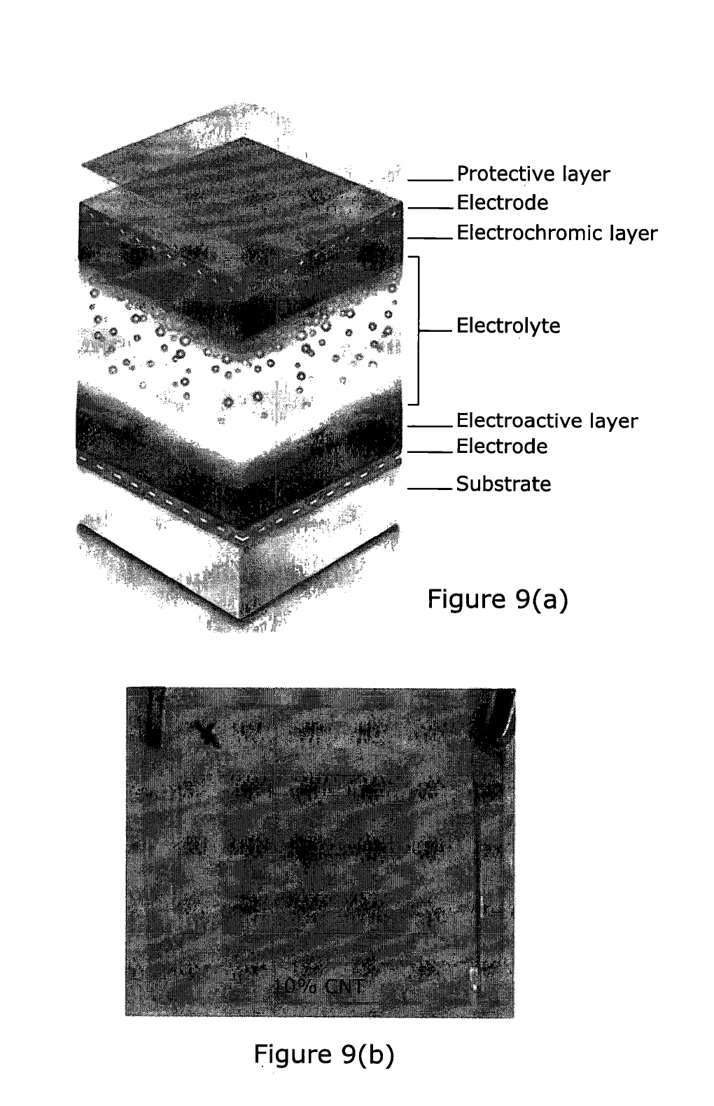

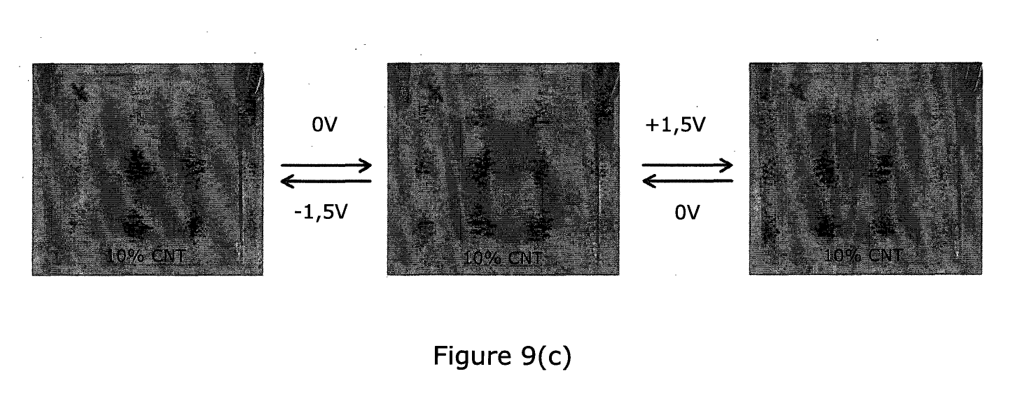

The architecture of the devices is similar to the one described for tungsten oxide electrochromic devices, where both electrodes and counterelectrodes are copolymer or copolymer+MWCNTs at different percentages, coated on PET by spray-casting, in FIG. 9(a) the schematic representation. This architecture allows the measurement of light absorption between oxidized and reduced states, since the patterns of the electrode and counter electrode are different, the monitored area is selected at one electrode, and it is not overlapped with the image printed at the other electrode. In FIG. 9(b) the picture of our ECD at the neutral state, while in the FIG. 9(c) is showed the ECD in the three different states: reduced, neutral and oxidized state respectively at −1.5 V, 0 V, and 1.5 V. A lithium-based UV curable electrolyte denominated YnvEI® described on the patent no US20140361211A1 separates the two electrodes and the device is closed and sealed.

### Example 10

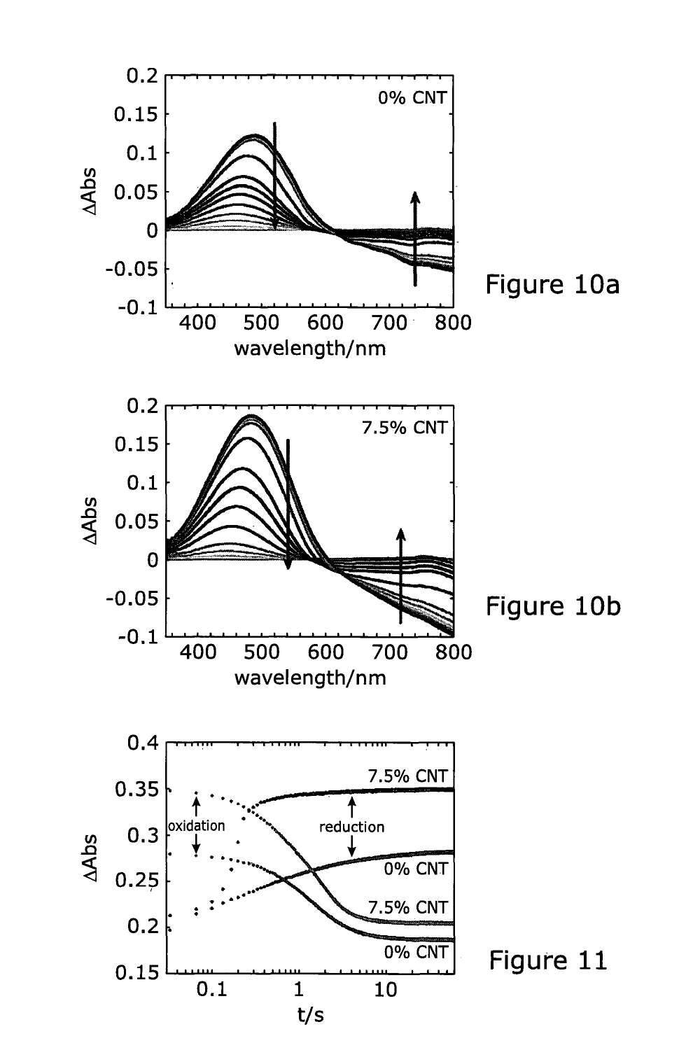

The optical properties of the copolymer/CNT thin-films in the electrochromic devices have been characterized by spectroelectrochemistry in the wavelength range of 300-800 nm and voltage range of −1.5 to 1.5 V. The measurements were made on a solid-state electrochromic cell, which contained all the components of the device, including the TCO and electrolyte layers. FIG. 10 shows the change in absorbance (AA) when a voltage is applied on the device, between the blue (i.e., positive voltage, oxidized copolymer) and the orange (i.e., negative voltage, reduced copolymer) states, the addition of the MWCNTs at the value of 7.5% w has a positive effect in the device, increasing the AA of the neutral and oxidized state.

### Example 11

Thanks to the spectroelectrochemistry analysis we have been able to determine the general features of an electrochromic device. By increasing the percentage of MWCNTs in the blend preparation, the most noticeable effect is the increase of ΔA, probably due to a more efficient electron-injection into the thin-layer but it may also be caused by the increased thickness of the thin-films when MWCNTs are present. The most dramatic effect is shown on Table 6 and FIG. 11 where the reduction switching times, τ_{red}, decrease by one order of magnitude (from 4 s to about 300 ms) by addition of 7.5% w of MWCNTs, while oxidation switching time, τ₀ₓ, remains fairly constant. In the same case another remarkable features are observed, namely equal values of total charge in oxidation and reduction cycles (Qₒₓ and Q_{red}), which are important for the electrochemical stability of the devices. Also the Coloration efficiency (CE) increases although the effect is not very pronounced. The remarkable effect on τ_{red} indicates a very fast electron-injection in the thin-film, promoted by the presence of MWCNTs. The value is indeed one of the fastest when compared with previous literature. In the supplementary material a real-time video shows the difference of performance between electrochromic devices without and with MWCNTs.

The applied voltage has also an important role. As expected, for values below 1 V the optical activity is negligible. The optimal effect is reached with 1.5 V, since above some degradations start to occur due to secondary electrochemical reactions. The number of layers mainly influences the oxidation switching time, which decreases to about 1 s when only 1 layer is deposited in the presence of 7.5% MWCNTs.

TABLE 6
Electric current, transition time between redox states, coloration efficiency,
change in absorbance and in transmittance of assembled electrochromic devices.
Influence of CNT (E = 1.5 V, 9 layers)

| | Q_{red} | Qₒₓ | | | CE | τₒₓ | τ_{red} |
|---|---|---|---|---|---|---|---|
| % CNT | (mC · cm⁻²) | (mC · cm⁻²) | Δ % T | ΔAbs | (cm² C⁻¹) | (s) | (s) |
| 0 | −0.89 | 1.13 | 12.9% | 0.097 | 71.5 | 4.6 | 3.8 |
| 2.5 | −1.09 | 1.08 | 14.5% | 0.107 | 90.8 | 4.9 | 0.5 |
| 5.0 | −1.22 | 1.16 | 13.8% | 0.103 | 80.0 | 4.6 | 0.3 |
| 7.5 | −1.33 | 1.36 | 17.8% | 0.148 | 99.2 | 3.6 | 0.3 |
| 10.0 | −1.82 | 1.62 | 18.9% | 0.190 | 98.9 | 6.6 | 0.3 |

Influence of E (7.5% CNT, 9 layers)

| | Q_{red} | Qₒₓ | | | CE | τₒₓ | τ_{red} |
|---|---|---|---|---|---|---|---|
| E/V | (mC · cm⁻²) | (mC · cm⁻²) | Δ % T | ΔAbs | (cm² C⁻¹) | (s) | (s) |
| 0.5 | −0.05 | 0.05 | 0.6% | 0.008 | 84.8 | 16.0 | 14.0 |
| 1.0 | −0.24 | 0.25 | 6.4% | 0.060 | 220.5 | 11.0 | 0.9 |
| 1.25 | −0.65 | 0.71 | 16.6% | 0.142 | 189.5 | 3.1 | 0.4 |
| 1.5 | −1.33 | 1.36 | 17.8% | 0.148 | 96.6 | 3.6 | 0.3 |
| 1.8 | −2.26 | 2.64 | 18.8% | 0.166 | 58.0 | 2.5 | 0.3 |

Influence of number of layers (7.5% CNT, E = 1.5 V)

| | Q_{red} | Qₒₓ | | | CE | τₒₓ | τ_{red} |
|---|---|---|---|---|---|---|---|
| layers | (mC · cm⁻²) | (mC · cm⁻²) | Δ % T | ΔAbs | (cm² C⁻¹) | (s) | (s) |
| 3 | −0.47 | 0.58 | 9.3% | 0.061 | 106.8 | 1.1 | 0.2 |
| 6 | −0.91 | 0.93 | 10.5% | 0.078 | 77.4 | 2.3 | 0.2 |
| 9 | −1.33 | 1.36 | 17.8% | 0.148 | 99.2 | 3.6 | 0.3 |
| 12 | −1.99 | 1.93 | 18.1% | 0.172 | 81.8 | 7.1 | 0.4 |
| 15 | −2.10 | 2.10 | 18.6% | 0.177 | 79.4 | 7.3 | 0.5 |

A special room has been used to calculate the color coordinates during the electrochromic transition of the solid-state cell, equipped with a digital camera under diffuse light inside.

Afterwards the pictures were analyzed by calibration with a ColorChecker®, in order to calculate L*, a* and b*. These results were then converted to color contrast values ΔE* using the oxidized state as reference (1.5 V) at the first cycle, after calculating ΔL*, Δa* and Δb*:ⁱ

ΔL*=|L*ₒₓ−L*(t)| (1a)

Δa*=|a*ₒₓ−a*(t)| (1b)

Δb*=|b*ₒₓ−b*(t)| (1c)

ΔE*=\sqrt{(ΔL*)²+(Δa*)²+(Δb*)²} (d)

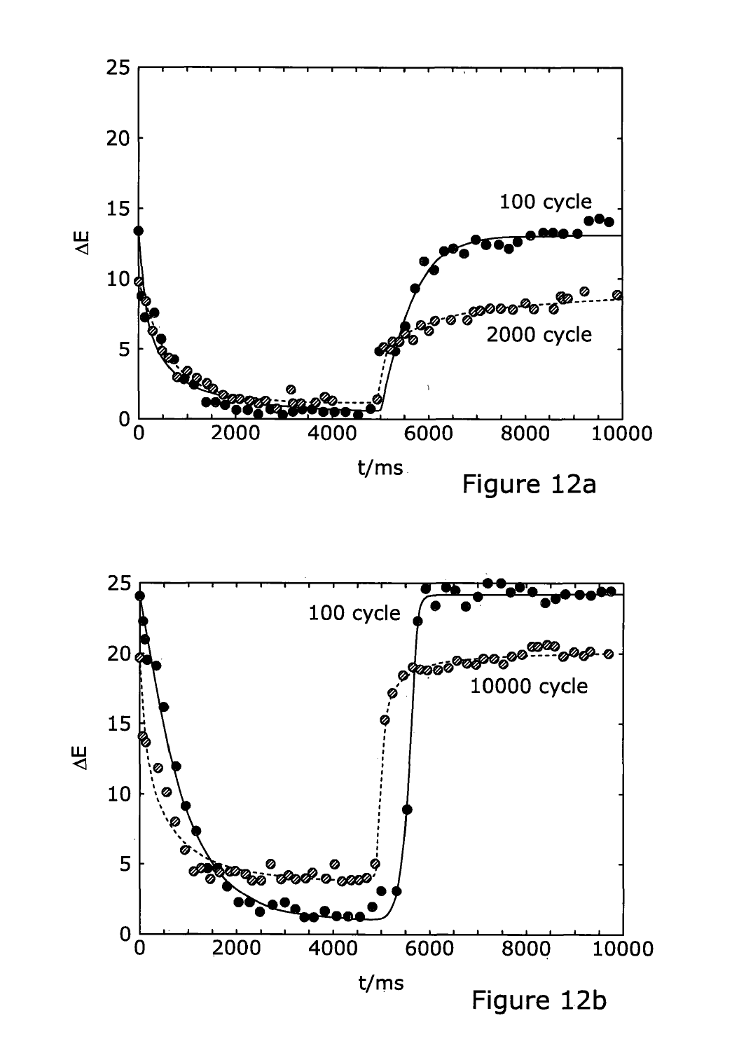

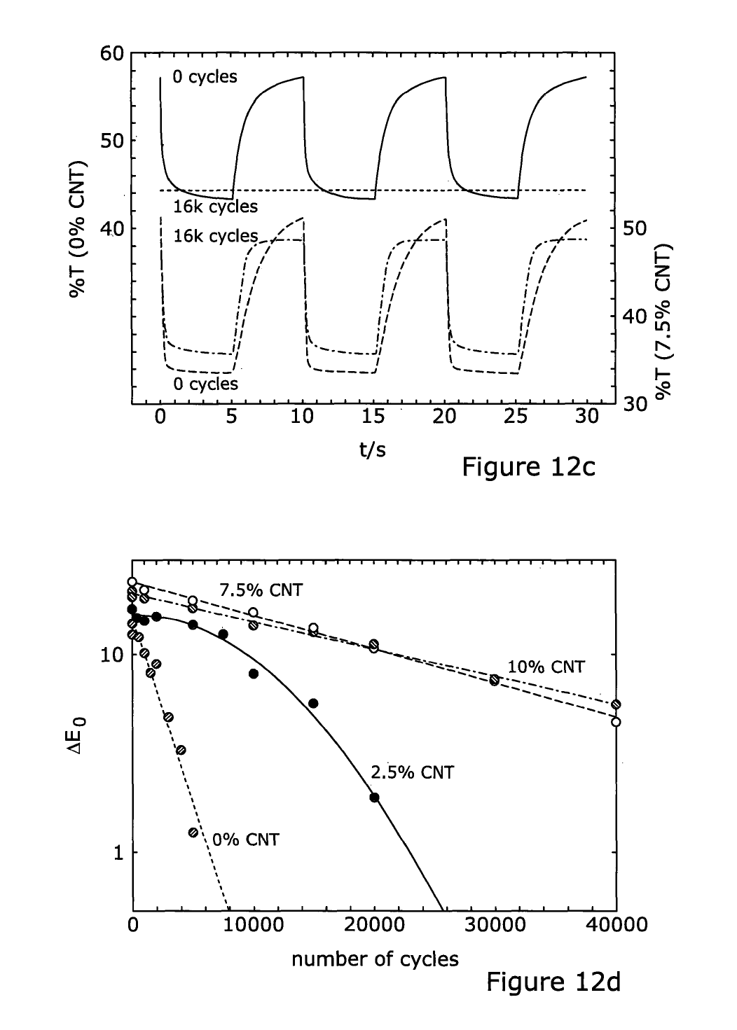

The FIG. 12(a-b) shows the ΔE depending on the number of cycles applied to the device. The resulting film coated on the surface without MWCNTs shows a significant degradation after 2000 cycles (see FIG. 12(a)), while the film containing the 7.5% of MWCNTs after 10000 cycles the device degradation is still rather small (see FIG. 12(b)). In the plots shown in FIG. 12(c), the zigzag trend represents the transmittance values of the device without (red trend) and with the addition of 7.5% of MWCNTs (dark trend). Moreover, to have a direct comparison of the endurance of the two different devices, in the same plot are compared the transmittance values at the first cycles and after 16000 cycles. After this treatment, the device without MWCNTs does not present anymore changes in term of transmittance, that is a direct proof of the total decay of the device, while in the case of the device with MWCNTs the grey part shows a transmittance that is rather the same with respect to the transmittance after the first cycles (black trend). With the same technique, we were able to run four different devices having different amounts of MWCNT in the blend, checking the ΔE depending on the number of cycles. The plot illustrated in Figure (d) clearly shows how the addition of the carbonaceous material increases the life of the device. After 40.000 cycles, the device containing 7.5% of MWCNTs loses just the half of the ΔE₀, while in the case of 0% of MWCNTs the device loses any electrochromic activities after 10.000 cycles. By increasing the percentage of MWCNTs (10%) we observe that there is no substantial improvement of the device.

### Example 12

The synthesis of the new copolymer 1 and its mixture of MWCNTs allows to obtain stable solutions in organic solvents of the two components, thanks to the solubilizing properties of the alkyl chains and pyrene unit present in the two different monomers, that with a strong π-π interaction interacts with the MWCNTs. The formulation of a stable solution and the choose of the spray coating give the chance to prepare homogenous films that are characterized by several techniques. The morphological and electrochemical characterizations of the films prove the direct correlation between the homogeneity of the films and the performances of the devices, that in our case are associated to the switching times (τ_{red}) and the endurance (number of cycles). Moreover the performances of the device are improved by adding a certain percentage of MWCNTs, corresponding to the 7.5% w with respect to copolymer 1. The reason for the outstanding stability of the devices with MWCNTs may be connected with secondary electrochemical processes (e.g., degradation of electrolyte layer) which are prevented by MWCNTs. For the electrochemical stability of the devices, the difference in the total charge in the oxidation and reduction cycles (Qₒₓ and Q_{red}) is also important. By adding 7.5% MWCNTs, the difference in terms of the total charge values during the redox process is very small. The most plausible explanation is that MWCNTs will scavenge the excess electric charges injecting them back to the ITO layer. Through the systematical studies, which has been made possible only by the formulation of a stable blend of copolymer 1 and MWCNTs, we have found that the characteristics to obtain the best ECD are the following: 9 layers of the blend on PET-ITO containing the 7.5% w of MWCNTs with respect to copolymer 1 with an applied voltage of 1.5 V.

1. A copolymer formed from at least one monomer of formula (A) and at least one monomer of formula (B) 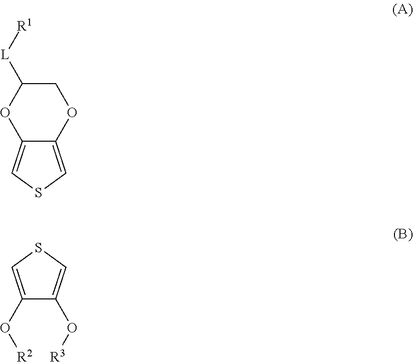
where R¹ is a polyaromatic or polyheteroaromatic ring or molecular graphenes of less than 22.000 g/mol;
L is a C₁₋₆ alkylene, C₂₋₅ alkenylene or C₂₋₆ alkynylene linker wherein one or two carbon atoms are optionally replaced with O, S or NH;
each of R² to R³ are independently selected from the group consisting of:
C₆₋₁₄ alkyl, which may optionally comprise a C₃₋₇ cycloalkyl, C₆₋₁₀ aryl or C₅₋₁₀ heteroaryl group and wherein a carbon atom of the alkyl chain is optionally replaced with O, S or NH;
C₃₋₇ cycloalkyl, C₆₋₁₀ aryl or C₅₋₁₀ heteroaryl;
a polyalkylene glycol radical;
or R² and R³ together with the atoms to which they are attached may form a 5-10 membered heterocyclic ring, optionally containing a further heteroatom selected from O, S or NH; and
the molar ratio of the monomer of formula (B) to the monomer of formula (A) is from 3:1 to 15:1.

2. A copolymer according to claim 1 wherein each of R² to R³ are independently selected from the group consisting of:
C₆₋₁₄ alkyl, which may optionally comprise a C₃₋₇ cycloalkyl, C₆₋₁₀ aryl or C₅₋₁₀ heteroaryl group and wherein a carbon atom of the alkyl chain is optionally replaced with O, S or NH;
C₃₋₇ cycloalkyl, C₆₋₁₀ aryl or C₅₋₁₀ heteroaryl;
or R² and R³ together with the atoms to which they are attached may form a 5-10 membered heterocyclic ring, optionally containing a further heteroatom selected from O, S or NH.

3. A copolymer according to claim 1 wherein the ratio of monomer (B) to monomer (A) is from 8:1 to 12:1.

4. A copolymer according to claim 1 which is a polymer of general formula (I) 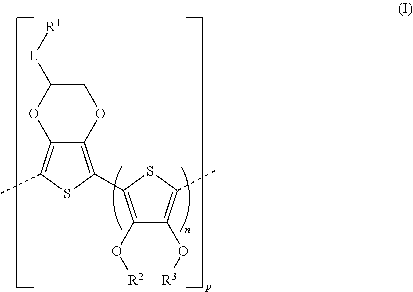
wherein L, R¹, R² and R³ are defined in claim 1 or claim 2 and wherein, within the polymer of general formula (I), R¹ groups may have differing values, R² groups may have differing values and R³ groups may have differing values;
n is 3-15; and
p is 3-140.

5. A copolymer according to claim 1 wherein R¹ is a polyaromatic ring system selected from the group consisting of benzo[a]pyrene, anthracene, chrysene, pyrene, phenanthracene, naphthalene and tetracene or a polyheteroaromatic group selected from indole, quinoline, isoquinoline and polypyrroles,

6. A copolymer according to claim 5 wherein R¹ is pyrene.

7. A copolymer according to claim 1 wherein L is a C₁₋₄ alkylene linker, wherein one carbon atom is optionally replaced with O, S or NH.

8. A copolymer according to claim 7 wherein L is:
—CH₂—, —CH₂CH₂—, —CH₂O—, —OCH₂—, —CH₂CH₂CH₂—, —CH₂OCH₂— or —CH₂NHCH₂—.

9. A copolymer according to claim 1 wherein each of R² and R³ is independently C₈₋₁₂ alkyl and optionally comprises a C₃₋₇ cycloalkyl ring.

10. A copolymer according to claim 1 wherein R² and R³ are the same.

11. A copolymer according to claim 1 wherein the monomer of formula (A) is 2-((pyren-1-ylmethoxy)methyl)-2,3-dihydrothieno[3,4-b][1,4]dioxine; and/or
the monomer of formula (B) is 3,4-bis((2-ethylhexyl)oxy)thiophene.

12. A process for the preparation of a polymer according to claim 1, the process comprising reacting a monomer of formula (A) as defined above with a monomer of formula (B) as defined above in the presence of an oxidising agent, wherein the molar ratio of the monomer of formula (B) to the monomer of formula (A) is from 3:1 to 15:1.

13. A process according to claim 12 wherein the oxidising agent comprises iron (III) chloride, which is present in excess.

14. A dispersion or solution comprising a copolymer according to claim 1 and an organic solvent.

15. A dispersion or solution according to claim 14 wherein the organic solvent is selected from the group consisting of include toluene, N,N-dimethylformamide (DMF), acetonitrile, tetrahydrofuran (THF), ethyl acetate, chloroform and mixtures thereof.

16. A dispersion or solution according to claim 15 wherein the organic solvent is a mixture of chloroform and toluene, preferably a mixture of toluene:chloroform in a volume ratio of 1:1 (v/v) to 1:10 (v/v).

17. A dispersion or solution according to claim 14 wherein the copolymer is present at a concentration of from 0.5 to 1.5 g/l.

18. A dispersion or solution according to claim 14 further comprising carbon nanostructures, wherein said carbon nanostructures are selected from the group consisting of carbon-based nanotubes, sheets, nanocones, nanohorns, nanoribbons, nanoplatelets, nanofibers, graphene, crystalline nanoparticles, nanodots, graphene quantum dots and amorphous nanoparticles.

19. A dispersion or solution according to claim 18, wherein said carbon nanostructures are metal-containing carbon nanostructures, which preferably contain a metal selected from the group consisting of iron, cobalt, nickel, copper, gold, silver, tin, palladium and platinum.

20. A dispersion or solution according to claim 18, wherein said carbon nanostructures are nanotubes, wherein said nanotubes are selected from single wall carbon nanotubes (SWCNTs) and multi wall carbon nanotubes (MWCNTs).

21. A dispersion or solution according to claim 20 wherein the carbon nanotubes are MWCNTs, especially pristine MWCNTs.

22. A dispersion or solution according to claim 18 which comprises 2-15 wt % carbon nanostructures, wherein weight percentages are given with respect to the polymer.

23. A substrate coated or printed with a coating or printing composition comprising a copolymer according to claim 1.

24. A coated or printed substrate according to claim 23 wherein the coating or printing composition is obtainable by providing a dispersion or solution comprising the copolymer and an organic solvent, and removing the solvent.

25. A coated or printed substrate according to claim 23, wherein, independently or in combination said substrate is one or more of:
in form of a film or panel;
optically transparent;
formed from a fibrous material or is glass or a polymer selected from acrylic, polystyrene, polycarbonate, allyl diglycol, styrene acrylonitrile copolymer, poly(4-methyl 1-pentene), polyester, polyamide or polyethylene terephthalate (PET);
flexible.

26. A coated or printed substrate according to claim 25 wherein the substrate is a PET substrate.

27. A coated or printed substrate according to claim 23 wherein the substrate further comprises an electrically conductive material.

28. A coated or printed substrate according to claim 27 wherein the substrate is indium doped tin oxide coated PET (PET-ITO).

29. A coated or printed substrate according to claim 23 wherein the substrate has a thickness of between 0.01 mm to 10 mm.

30. A coated or printed substrate according to claim 23 which comprises 2-12 layers of the coating composition.

31. A coated or printed substrate according to claim 23, wherein the total thickness of the combined layers of the coating as defined by Atomic Force Microscopy is suitably from 100-500 nm.

32. A method for preparing a coated or printed substrate comprising the steps of:
i) Providing a dispersion or solution comprising a copolymer and an organic solvent, the copolymer being formed from at least one monomer of formula (A) and at least one monomer of formula (B) 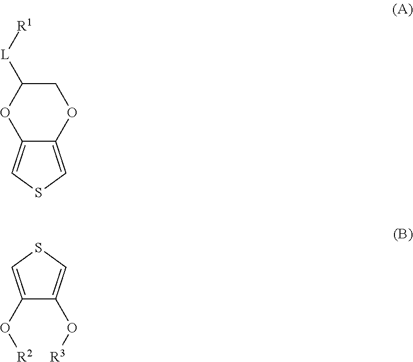
where R¹ is a polyaromatic or polyheteroaromatic ring or molecular graphenes of less than 22.000 g/mol;
L is a C₁₋₆ alkylene, C₂₋₅ alkenylene or C₂₋₆ alkynylene linker wherein one or two carbon atoms are optionally replaced with O, S or NH;
each of R² to R³ are independently selected from the group consisting of:
C₆₋₁₄ alkyl, which may optionally comprise a C₃₋₇ cycloalkyl, C₆₋₁₀ aryl or C₅₋₁₀ heteroaryl group and wherein a carbon atom of the alkyl chain is optionally replaced with O, S or NH;
C₃₋₇ cycloalkyl, C₆₋₁₀ aryl or C₅₋₁₀ heteroaryl;
a polyalkylene glycol radical;
or R² and R³ together with the atoms to which they are attached may form a 5-10 membered heterocyclic ring, optionally containing a further heteroatom selected from O, S or NH; and
the molar ratio of the monomer of formula (B) to the monomer of formula (A) is from 3:1 to 15:1;
ii) Applying the dispersion onto the substrate using a suitable coating or printing method; and
iii) Removing the solvent.

33. A method according to claim 32 wherein the coating or printing method is spray coating.

34. An electrochromic device comprising a coated or printed substrate according to claim 23.

35. An electrochromic device according to claim 34 comprising electrodes and/or counter electrodes formed from the coated or printed substrate.

36. A product comprising an electrochromic device of the invention according to claim 35 wherein the product is selected from the group consisting of windows, displays, monitors, sun shades, mirrors, wearable objects, furniture, toys, labels, documents or packaging.

37. An electrochromic ink comprising a dispersion or solution according to claim 14.
